(19) United States
(12) Patent Application Publication
(10) Pub. No.: US 2020/0062882 A1
(43) Pub. Date: Feb. 27, 2020

(54) ULTRAHIGH MOLECULAR WEIGHT BLOCK COPOLYMERS AND POLYMERS, METHODS OF MAKING SAME, AND USES OF SAME

(71) Applicant: The Research Foundation for The State University of New York, Amherst, NY (US)

(72) Inventors: Javid RZAYEV, Williamsville, NY (US); Jose MAPAS, Hillsboro, OR (US); Haiqing LIN, Buffalo, NY (US)

(21) Appl. No.: 16/610,451

(22) PCT Filed: May 4, 2018
(86) PCT No.: PCT/US2018/031215

§ 371 Date: Nov. 1, 2019

Related U.S. Application Data
(60) Provisional application No. 62/501,461, filed on May 4, 2017.

(51) Int. Cl. C08F 293/00; C09D 153/00; C08J 7/04; B01D 71/80; B01D 71/28; B01D 71/40; B01D 69/02; B01D 67/00; B01D 61/14; B01D 61/24; C02F 1/44

(52) U.S. Cl. CPC C08F 293/005; B01D 61/027; C08J 7/047; B01D 71/80; B01D 71/28; B01D 71/40; B01D 69/02; B01D 67/0009; B01D 61/145; B01D 61/243; C02F 1/444; C08F 2438/03; C08J 2333/20; C08J 2453/00; C09D 153/00

(57) ABSTRACT

Provided are UHMW polymers having a molecular weight of 500 kg/mol or greater. The UHMW polymers can be block copolymers, homopolymers, and random/statistical copolymers. The UHMW polymers can be used to form porous layers, which may be used in filtration membranes, such as, for example, ultrafiltration membranes. The filtration membranes can be used in various separation methods.

### CROSS REFERENCE TO RELATED APPLICATIONS

This application claims priority to U.S. Provisional Application No. 62/501,461, filed on May 4, 2017, the disclosure of which is hereby incorporated by reference.

### STATEMENT REGARDING FEDERALLY SPONSORED RESEARCH

This invention was made with government support under contract no. DMR-1409467 awarded by the National Science Foundation. The government has certain rights in the invention.

### FIELD OF THE DISCLOSURE

The disclosure generally relates to ultrahigh molecular weight polymers. More particularly, the disclosure relates to porous membranes formed using ultrahigh molecular weight block copolymers.

### BACKGROUND OF THE DISCLOSURE

Block copolymers (BCP) are an important class of soft materials that feature two or more chemically distinct polymer blocks covalently linked together. Block copolymer (BCP) derived periodic nanostructures with domain sizes larger than 150 nm present a versatile platform for the fabrication of photonic or membrane materials. So far, the access to such materials has been limited to highly synthetically involved protocols.

Thermodynamic incompatibility between the blocks drives microphase separation in melt state, producing periodic nanomaterials whose morphology and domain sizes are dictated by the copolymer composition and molecular weight. Owing to the tunable physical and chemical characteristics of block copolymers and easily accessible domain sizes of <100 nm, BCP-derived materials have found numerous applications in nanotechnology. On the other hand, ordered nanomaterials with periods larger than 150 nm hold notable importance for applications involving polarizers and photonic band gap structures as these can respond to visible light. However, the access to periodic materials with such large domain sizes, which requires the use of ultrahigh molecular weight block copolymers, is extremely limited due to synthetic challenges associated with the preparation of very long linear block copolymers, and kinetic limitations in the self-assembly of highly entangled ultrahigh molecular weight block copolymer melts. So far, arduous anionic polymerizations have afforded the exclusive synthetic pathway to ultrahigh molecular weight linear block copolymer based materials, while kinetic limitations have been addressed by utilizing BCPs with a brush-like molecular architecture, exhibiting low density of entanglements. In both cases, laborious synthetic protocols are required, which limits the availability of large domain size nanomaterials to a broader scientific community.

Reversible-deactivation radical polymerization (RDRP) has been used to produce well-defined polymers having linear, branched, comb, star, and network architectures. The precise control over molecular dimensions and architecture stems from the dynamic equilibrium between active and dormant polymer chains, achieved either by reversible deactivation, such as the case in atom transfer radical polymerization (ATRP), or by reversible transfer, which occurs in reversible addition-fragmentation chain-transfer (RAFT) polymerization. Compared to anionic polymerizations, RDRPs are more tolerant to functional groups, applicable to a broader range of monomers, and require less stringent conditions. Recently, there has been progress in circumventing inherent limitations of RDRP and developing protocols to achieve homopolymers with ultrahigh molecular weights. Various ultrahigh molecular weight poly(meth)acrylates have been synthesized by Cu-mediated processes and by high-pressure RAFT polymerization. Despite an increasing number of procedures for the synthesis of ultrahigh molecular weight (meth)acrylic homopolymers, the access to ultrahigh molecular weight linear block copolymers by RDRP methods has been very limited, highlighting the difficulty of re-initiating the second block off a very long polymer chain. The synthesis of ultrahigh molecular weight poly(methyl methacrylate-b-butyl methacrylate) and poly(methyl methacrylate-b-methyl acrylate) by ATRP processes was previously reported. The synthesis of a highly compositionally asymmetric and polystyrene-rich amphiphilic block copolymer by emulsion RAFT polymerization was also previously reported. However, RDRP synthesis of ultrahigh molecular weight linear block copolymers that phase separate into ordered periodic nanostructures has not been reported to date.

The broad array of structural diversity exhibited by porous materials has led to its utility in adsorption, catalysis, separation, purification, and energy applications. Various types of organic and inorganic precursors have been engineered using a collection of top-down and bottom-up techniques in an effort to precisely tune key features such as pore size, morphology, and membrane dimensions to align with desired functions. Among the different classes of porous solids, organic polymers are the most pervasive due to their functional diversity, high processability and low cost. In particular, self-assembled block copolymers (BCPs) have received significant attention as materials for challenging membrane applications owing to their controllable pore dimensions, narrow pore size distribution, high porosity, and tunable chemical and mechanical properties. A noticeable limitation, however, is the fabrication of robust membranes with sub-10 nm pore sizes and sharp molecular weight cutoffs, which can be used towards the isolation of low molecular weight proteins or removal of small bacterial and viral contaminants in groundwater. BCPs that microphase separate to form sub-10 nm domains are promising candidates to generate membranes with such small pore sizes. However, the limited number of BCPs that can access sub-10 nm domain dimensions, the relatively fragile nature of these copolymers due to their low molecular weights, and the difficulty in controlling cylindrical domain alignment for copolymers with such small domain sizes preclude their utility as membrane materials. It was previously reported that a four-fold increase in BCP molecular weight results in a three-fold enhancement in the applied pressure to rupture the membrane. Therefore, lower molecular weight that allows access to nanopores with small dimensions also has a detrimental effect on membrane mechanical properties.

Composite membranes with a thin selective layer and an underlying thick macroporous substrate have emerged as materials of choice for enabling faster flow rates across the membrane without sacrificing selectivity. A thin selective layer imparts excellent separation behavior, while the porous substrate ensures high permeability and provides good mechanical stability to the membrane. Selective layers have can be produced from self-assembled BCPs by the removal of one of the components through UV degradation, ion etching, and chemical etching. Proper alignment of phase separated BCP cylindrical domains is imperative to maximizing pore formation and enhancing flow rates across the membrane. Various efforts have been made at aiming to control the orientation and ordering of microdomains in BCP materials. Perpendicular alignment of domains in BCP-based membrane materials has been achieved by neutralizing the substrate, solvent vapor annealing, increasing the evaporation rate of the casting solvent, and incommensurability between film thickness and domain spacing. It was previously observed that a relatively thick (˜4 μm) nanoporous membranes from poly(styrene)-b-poly(lactide) (PS-PLA) casted using a selective solvent exhibited low flow rates due to the pores not spanning the entire thickness of the selective layer, which is a consequence of the decreased driving force for perpendicular alignment of cylindrical domains 100 nm into the film surface. By introducing a polyisoprene block between the PS and PLA chains, a composite membrane with a mechanically robust thin selective layer containing 24 nm cylindrical pores that showed enhanced flow rates relative to the bulk PS-PLA system was previously produced. This illustrates that reducing the copolymer film thickness offers a possibility of proper domain orientation and faster transport rates, but may compromise the mechanical stability of the membrane. Controlling pore alignment in BCP with domain sizes small enough to generate sub-10 nm pores presents additional challenges, as the required film thicknesses would not be sufficient to ensure proper mechanical integrity. To circumvent these limitations, various diblock and triblock copolymer based strategies with post fabrication modifications have been recently employed for the preparation of membranes with sub-10 nm pore sizes. It was previously demonstrated that partial removal of a minority block component from a phase separated multiblock copolymer can be used to access sub-10 nm pore dimensions. While these materials demonstrate some excellent properties, their usability remains limited due to demanding synthetic protocols, large amounts of the BCP precursor, complex post-assembly modifications, film thicknesses or complex film transfer procedures required to produce the membranes.

Commercial ultrafiltration and nanofiltration membranes have broad pore size distributions and are thousands of times thicker than the molecules they are designed to separate, resulting in filtrate loss within the membrane and poor transport and size cutoff properties. The practical utilization of block copolymer derived filtration membranes is severely hindered due to the following challenges:

(1) Difficulty and the cost associated with the block copolymer synthesis.
(2) Limited range of molecular weights available for self-assembly (and therefore limited range of membrane pore sizes attainable), either due to synthetic challenges (high end) or self-assembly thermodynamics (low end).
(3) Morphology orientation. Typically, membranes are prepared from block copolymers forming cylindrical morphologies where selective etching of the minor component produces cylindrical pores for which it is difficult to achieve pores oriented perpendicular to the membrane surface. This orientation is difficult to achieve with block copolymers, and thus is a significant challenge toward membrane preparation.
(4) Preparation of membranes with a thin selective layer. For size selective separations, such as ultrafiltration and nanofiltration, a very thin (<100 nm) selective layer is desired in order to maintain high flux through the membrane while achieving high selectivity. This thin layer has to be deposited on a highly porous substrate with much larger pores to provide mechanical support. Such composite membranes are difficult to fabricate from block copolymers due to the challenges associated with the preparation of the thin selective layer itself (as described in point (3)) or with the transfer of the selective layer onto the substrate.
(5) Another disadvantage of the existing block copolymer derived membranes is their hydrophobicity, which is partly necessitated by their utilization in water based applications (the matrix cannot be water soluble). When the minority component is fully etched to produce cylindrical pores, the resulting naked matrix is hydrophobic and prone to fouling and biofouling in typical water purification applications, resulting in low lifetimes and decreased fluxes. (6) (Bio)Fouling is also a major problem for commercially available ultrafiltration membranes.

Based on the foregoing, there exists and ongoing and unmet need for polymers with improved properties for use in filtration membranes.

### SUMMARY OF THE DISCLOSURE

The present disclosure provides ultrahigh molecular weight (UHMW) polymers and UHMW block copolymers. The present disclosure also provides methods of making UHMW polymers and block copolymers and uses of UHMW polymers and block copolymers.

In an aspect, the present disclosure provides UHMW block copolymers. The block copolymers can be UHMW linear block copolymers. In an example, a UHMW polymer is made by a method of the present disclosure. Examples of UHMW block copolymers and methods of making UHMW block copolymers are provided in Example 1.

In an example, UHMW block copolymers comprise a porogen block (also referred to herein as a first block or a minority block) and a matrix block (also referred to herein as a second block or a majority block). The porogen and/or matrix block can be homopolymers or copolymers (e.g., random/statistical copolymers).

In an aspect, the present disclosure provides UHMW polymers. In various examples, the UHMW polymers are UHMW homopolymers or UHMW copolymers (e.g., random copolymers, statistical copolymers, and the like). In an example, a UHMW polymer is made by a method of the present disclosure. For example, a UHMW polymer is made by a Cu-mediated RDRP and RAFT process.

A UHMW polymer comprises acrylate moieties and/or methacrylate moieties. In various examples, all of the polymer units forming a polymer comprise acrylate moieties, methacrylate moieties (e.g., solketal methacrylate moieties, which may be chiral moieties, optionally, having the same chirality, methyl methacrylate moieties, hydroxyethyl methacrylate moieties, and the like), acrylamide moieties, methacrylamide moieties, vinyl pyridine moieties, or a combination thereof.

In an aspect, the present disclosure provides methods of making UHMW polymers and UHMW block copolymers of the present disclosure. The methods are based on reversible-deactivation radical polymerization (RDRP). For example, the methods are a combination of Cu-mediated RDRP and RAFT polymerization. FIG. 2 is an example of a method of the present disclosure.

In an example, a UHMW polymer or a UHMW block copolymer is made using a combination of Cu-mediated RDRP and RAFT polymerization. In an example, porogen block(s) is/are made using Cu-mediated RDRP and matrix block(s) is/are made using RAFT polymerization. The Cu-mediated RDRP and RAFT polymerization can be performed in any order. In an example, Cu-mediated RDRP is performed first (e.g., to make a porogen block) and RAFT polymerization performed second (e.g., to make a matrix block).

In an aspect, the present disclosure provides uses of UHMW block copolymers of the present disclosure. For example, UHMW block copolymers are used as materials for ultrafiltration membranes. Examples of ultrafiltration membranes comprising UHMW block copolymers and methods of making UHMW block copolymers are provided in Example 2. In various examples, an ultrafiltration membrane is used in water-filtration methods, water-purification methods, separation methods (such as, for example, bioseparation methods), drug delivery methods, and ultrafiltration methods, and nanofiltration methods.

The ultrafiltration membranes can be hydrophilic and resistant to biofouling. The methods used to make the ultrafiltration membranes are amenable to scalable and cost-effective manufacturing.

The ultrafiltration membranes can be used in purification methods. For example, a method of purification of a water sample comprises contacting an ultrafiltration membrane of the present disclosure with a water sample, where one more contaminants are at least partially or completely removed from the water sample. Non-limiting examples of contaminants include bacteria, viruses, other toxins, and the like.

The ultrafiltration membranes can be used in protein purification methods. An ultrafiltration membrane can be used to isolate one or more proteins from a liquid protein sample.

In an aspect, the present disclosure provides devices comprising one or more ultrafiltration membrane of the present disclosure. In an example, a device is a filtration or purification device. Example of filtration devices include, but are not limited to, water filtration devices, water purification devices, and the like.

### BRIEF DESCRIPTION OF THE FIGURES

For a fuller understanding of the nature and objects of the disclosure, reference should be made to the following detailed description taken in conjunction with the accompanying figures.

FIG. 1 shows fabrication of large domain spacing photonic nanomaterials from UHMW BCPs prepared by radical polymerization.

FIG. 2 shows a synthesis of UHMW block copolymers by RDRP.

FIG. 3 shows polymerization of solketal methacrylate ([SM]: [CDB]:[Me₆TREN]=2,000:1:1). (A) First-order kinetic plot, (B) evolution of molecular weight and dispersity with conversion, (C) SEC analysis of PSM homopolymers, and (D) SEC characterization of PSM-PS block copolymer. The numbered lines in (C) correspond to the polymers in (A) moving from left to right.

FIG. 4 shows USAXS and SEM analyses of block copolymers (A) SK-1 and (B) SK-2 with cylindrical morphology, and (C) SK-3 and (D) SK-4 with lamella morphology.

FIG. 5 shows transmittance spectra of UHMW PSM-PS block copolymer thin films, and optical images illustrating reflected (top row) and transmitted (bottom row) colors of the prepared films.

FIG. 6 shows an NMR spectrum of SK-1.

FIG. 7 shows an NMR spectrum of SK-2.

FIG. 8 shows an NMR spectrum of SK-3.

FIG. 9 shows an NMR spectrum of SK-4.

FIG. 10 shows an NMR spectrum of SK-5.

FIG. 11 shows an NMR spectrum of SK-6.

FIG. 12 shows polymerization of MMA ([MMA]:[CDB]:[Me₆TREN]=2,000:1:1). (A) Synthetic scheme, (B) SEC analysis of PMMA homopolymers, (C) first-order kinetic plot, and (D) evolution of molecular weight and dispersity with conversion. The numbered lines in (B) correspond to the polymers in (C) moving from left to right.

FIG. 13 shows polymerization of HEMA ([HEMA]:[CDB]:[Me₆TREN]=2,000:1:1). (A) Synthetic scheme, (B) SEC analysis of Acetylated PHEMA homopolymers, (C) first-order kinetic plot, and (D) evolution of molecular weight and dispersity with conversion. The numbered lines in (B) correspond to the polymers in (C) moving from left to right.

FIG. 14 shows SEC traces of (a) PSM precursor, and PSM-PS block copolymer SK-3: (b) as synthesized, (c) after washing in boiling acetonitrile, and (d) after washing in cyclohexane.

FIG. 15 shows differential scanning calorimetry analysis of PSM-PS block copolymer.

FIG. 16 shows USAXS and SEM analysis of PSM-PS block copolymers (A) SK-5, and (B) SK-6.

FIG. 17 shows fabrication of nanoporous materials from PSM-PS.

FIG. 18 shows self-assembly phase structures of PSM-PS copolymers. USAXS patterns and SEM images of five representative samples showing PS spheres (A and F) from KS(0.18,720), PS cylinders (B and G) from KS(0.35,530), lamella (C and H) from KS(0.63,397), PSM cylinders (D and I) from KS(0.79,690), and PSM spheres (E and J) from KS(0.90,1460).

FIG. 19 shows a morphology diagram for PSM-PS block copolymer. Circle, square, triangle, diamond, and cross markers denote PSM spheres, PSM cylinders, lamella, PS cylinders, and PS spheres, respectively.

FIG. 20 shows an illustration of the dependence of interfacial curvature and morphology to block copolymer dispersity.

FIG. 21 shows an acid-catalyzed ketal hydrolysis reaction of PSM-PS.

FIG. 22 shows an optical image and ¹H NMR spectra of pristine (A and B) and hydrolyzed (C and D) PSM-PS copolymer.

FIG. 23 shows SEM analyses of pore geometries from (A) PS cylinders, (B) lamella, and (C) PSM cylinders.

FIG. 24 shows composite membrane construction.

FIG. 25 shows TEM and SEM images of KS(0.75,910) before (A and C) and after (B and D) hydrolysis.

FIG. 26 shows a rejection curve.

FIG. 27 shows membrane fabrication.

FIG. 28 shows SEM characterization of a membrane surface. The left image shows the surface before hydrolysis and the right image shows the surface after hydrolysis.

FIG. 29 shows a preliminary solute rejection test. Water flux is described as follows: hydrolyzed PAN350 support: 341 L/m² h bar; hydrolyzed polymer-PAN350 support: 14 L/m² h bar.

FIG. 30 shows thermogravimetric analysis of poly(solketal methacrylate).

FIG. 31 shows an SEM image of KS(0.090,1460).

FIG. 32 shows an SEM image of KS(0.35,530) featuring hexagonally packed and disorganized cylinders.

FIG. 33 shows water-contact angle measurement of KS(0.75,910) before (A) and after (B) hydrolysis.

FIG. 34 shows a USAXS profile of KS(0.75,910) before (A) and after (B) hydrolysis.

FIG. 35 shows an optical image of KS(0.18,720) before (A) and after (B) hydrolysis.

FIG. 36 shows an SEM image of KS(0.75,910) with pores-oriented parallel to membrane surface.

### DETAILED DESCRIPTION OF THE DISCLOSURE

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

As used herein, unless otherwise stated, the term “group,” when used in the context of a chemical structure, refers to a chemical entity that has one terminus that can be covalently bonded to other chemical species. Non-limiting illustrative examples of groups include:

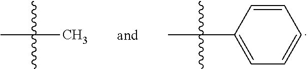

As used herein, unless otherwise stated, the term “moiety” refers to a chemical entity that has two or more termini that can be covalently bonded to other chemical species. Non-limiting illustrative examples of groups include:

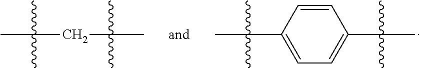

The present disclosure provides ultrahigh molecular weight (UHMW) polymers and UHMW block copolymers. The present disclosure also provides methods of making UHMW polymers and block copolymers and uses of UHMW polymers and block copolymers.

In an aspect, the present disclosure provides UHMW block copolymers. The block copolymers can be UHMW linear block copolymers. In an example, a UHMW polymer is made by a method of the present disclosure. Examples of UHMW block copolymers and methods of making UHMW block copolymers are provided in Example 1.

In an example, UHMW block copolymers comprise a porogen block (also referred to herein as a first block or a minority block) and a matrix block (also referred to herein as a second block or a majority block). The porogen and/or matrix block can be homopolymers or copolymers (e.g., random copolymers).

UHMW polymers can comprise various ranges (e.g., weight fractions) of porogen block and matrix block. In an example, a UHMW polymer has 10-50% weight fraction, including all 0.1% weight fraction values and ranges therebetween, porogen block(s) and/or 90-50% weight fraction, including all 0.1% weight fraction values and ranges therebetween, matrix block(s).

The porogen block(s) have a molecular weight (Mw or Mn) of 200-2000 kg/mol, including all integer values and ranges therebetween. In an example, at least or portion or all of the polymer units forming the porogen block comprise acrylate moieties, methacrylate moieties, vinyl pyridine moieties having an acid-reactive group or a base-reactive group. The porogen block may have one or more different acid-reactive group and/or one or more base-reactive group. Non-limiting examples of acid-reactive groups include ketal groups, acetal groups, ester groups, anhydride groups, carbonate groups, silyl ether groups. Non-limiting examples of base-reactive groups include ester groups, anhydride groups, carbonate groups, silyl ether groups. The porogen block can have one or more different acid- or base-reactive group(s) and non-reactive group(s) (groups which are not acid reactive or base reactive). At least a portion of an acid- or base-reactive group is cleaved (i.e., removed) from the group on reaction with an acid or base, respectively. The acid- or base-reactive group(s) and non-reactive group(s) are pendant groups (i.e., the group is covalently bound to the polymer backbone). In an example, porogen block has 10-100 mol percent reactive group(s) and the remainder non-reactive group(s), including all integer values and ranges therebetween. In an example, the polymer units forming the porogen block do not comprise an amine group, carboxylate group, or thiol group.

The matrix block(s) provide rigidity and/or stability. The matrix blocks have a molecular weight (Mw or Mn) of 200-2000 kg/mol, including all integer values and ranges therebetween. In an example, the polymer units forming the matrix block comprise acrylate moieties, methacrylate moieties, vinyl pyridine moieties, styrenic moieties (e.g., styrene moieties), saturated or unsaturated aliphatic moieties, substituted analogs thereof, and like, or a combination thereof. These moieties can be derived from polymerization of acrylate monomer(s), methacrylate monomer(s), vinyl pyridine monomer(s), styrenic monomers (e.g., styrene monomer(s)), olefin monomer(s), diene monomer(s), substituted analogs thereof, or a combination thereof.

It may be desirable that the matrix block has a Tg above room temperature (e.g., 20° C. or greater) and/or a UHMW polymer or block copolymer comprises at least one chemically cross-linked matrix block (e.g., a cross-linked matrix block comprising interchain and/or intrachain cross-linked (e.g., covalently crosslinked) groups)). In various examples, a matrix block such as, for example, polystyrene (or a polymer block formed from styrenic monomers), poly(methyl methacrylate), poly(vinyl pyridine), and the like, innately has a Tg above room temperature. In various examples, a matrix block with a Tg below room temperature (e.g., below 20° C.) is chemically crosslinked. In various examples, a UHMW polymer or block copolymer comprises at least one chemically cross-linked matrix block (e.g., a cross-linked matrix block comprising interchain and/or intrachain cross-linked (e.g., covalently crosslinked) groups). For example, a crosslinked matrix block is made from diene monomers, such as, for example, butadiene and isoprene. The UHMW polymer or block copolymer may be chemically crosslinked after thin-film formation.

A matrix block can be chemically crosslinked by methods known in the art. Non-limiting examples of chemical crosslinking include thermal crosslinking, ultraviolet light crosslinking, acid- or base-catalyzed crosslinking, metal catalyzed crosslinking, vulcanization, and the like.

In an example, one or more or all (e.g., 10-100 mol percent) of the porogen blocks have acid-reactive groups or base reactive groups. An acid-reactive group or base reactive group reacts with acid or base, respectively, to form one or more functional groups such as, for example, —OH groups. Examples of acid-reactive groups include, but are not limited to, ketal groups, acetal groups, ester groups, other functional groups that can be converted to alcohol (—OH) groups, and combinations thereof.

In an example, one or more or all of the porogen blocks have acid-reactive groups or base reactive groups and/or the UHMW block copolymer has a hydrophobic block (e.g., a polymer block formed from styrenic monomers (such as, for example, a polystyrene block), polyacrylate block, polymethacrylate block, polyolefin block, or polydiene block) having a high glass transition temperature (above room temperature).

UHMW block copolymers can have various molecular weights. In various examples, the UHMW block copolymers have a molecular weight (Mw or Mn) of 500 kg/mol or greater, 550 kg/mol or greater, 600 kg/mol or greater, 700 kg/mol or greater, 800 kg/mol or greater, 900 kg/mol or greater, or 1,000 kg/mol or greater. In an example, the UHMW block copolymers have a molecular weight (Mw or Mn) of 100 kg/mol to 2000 kg/mol. In an example, the UHMW block copolymers have a molecular weight (Mw or Mn) of 500 kg/mol to 2000 kg/mol.

UHMW block copolymers and/or individual blocks can have various dispersity. In an example, the UHMW block copolymers and/or individual blocks have a dispersity of 1.1-2, including all 0.01 values therebetween.

In an example, UHMW block copolymers comprise one or more polymethacrylate block, which may comprise acid-reactive groups or base-reactive groups, and/or one or more (e.g., a polymer block formed from styrenic monomers (such as, for example, a polystyrene block)). The polymethacrylate blocks can be solketal blocks. In an example, a UHMW block copolymer is a linear poly(solketal methacrylate-b-styrene).

A UHMW block polymer may have porogen block with moieties formed from a monomer having a chiral pendant group. In an example, a UHMW block copolymer has moieties with a chiral pendent group, where the chiral pendant groups have the same stereochemistry (e.g., the chiral pendant groups are all the same).

The copolymers have desirable features. In various examples, a UHMW block copolymer has one or more of the following features:
readily assemble into highly desirable periodic nanostructures with large domain sizes (>150 nm) and photonic properties;
ability to phase separate in bulk into ordered periodic nanostructures;
MW of total is >500 kg/mol.

The copolymers have various end groups. In an example, a copolymer has one or more sulfur-containing end-group.

UHMW block copolymers can self-assemble in thin-films. The block copolymers can exhibit bulk (solvent-free) phase separation. For example, UHMW block copolymers form a thin film (e.g., having a thickness of 20-200 nm) having a pitch (of individual domains) of 50-300 nm. In an example, UHMW block copolymers self-assemble into periodic nanostructures that have domains sizes of 150 nm or greater. The nanostructures can have photonic properties.

Thin films comprising UHMW block copolymers can have various morphologies. In various examples, thin films comprising UHMW block copolymers have spherical, cylindrical, lamella, or network morphology.

In an aspect, the present disclosure provides UHMW polymers. In various examples, the UHMW polymers are UHMW homopolymers or UHMW copolymers (e.g., random copolymers, statistical copolymers, and the like). In an example, a UHMW polymer is made by a method of the present disclosure. For example, a UHMW polymer is made by a Cu-mediated RDRP and RAFT process.

A UHMW polymer comprises acrylate moieties and/or methacrylate moieties. In various examples, all of the polymer units forming a polymer comprise acrylate moieties, methacrylate moieties (e.g., solketal methacrylate moieties, which may be chiral moieties, optionally, having the same chirality, methyl methacrylate moieties, hydroxyethyl methacrylate moieties, and the like), acrylamide moieties, methacrylamide moieties, vinyl pyridine moieties, or a combination thereof.

A UHMW polymer may have moieties formed from a monomer having a chiral pendant group. In an example, A UHMW polymer has moieties with a chiral pendent group, where the chiral pendant groups have only one stereoisomer of the chiral pendant group.

A UHMW copolymer can comprise acrylate moieties and/or methacrylate moieties and styrenic moieties (e.g., styrene moieties). For example, a UHMW copolymer comprises 0.1 to 50% by weight (based on the total weight of the polymer), including all 0.1% by weight values and ranges therebetween, styrenic moieties (e.g., styrene moieties).

UHMW polymers can have various molecular weights. In various examples, the UHMW polymers have a molecular weight (Mw or Mn) of 500 kg/mol or greater, 550 kg/mol or greater, 600 kg/mol or greater, 700 kg/mol or greater, 800 kg/mol or greater, 900 kg/mol or greater, or 1,000 kg/mol or greater. In an example, the UHMW block copolymers have a molecular weight (Mw or Mn) of 100 kg/mol to 2000 kg/mol. In an example, the UHMW polymers have a molecular weight (Mw or Mn) of 500 kg/mol to 2000 kg/mol including all integer kg/mol values and ranges therebetween.

UHMW polymers can have various dispersity. In an example, the UHMW polymers have a dispersity of 1.1-2, including all 0.01 values therebetween.

In an example, UHMW polymers comprise one or more methacrylate moieties. The polymethacrylate blocks may be solketal methacrylate blocks.

The polymers can have various end groups. In an example, a polymer has one or more sulfur-containing end-group.

In an aspect, the present disclosure provides methods of making UHMW polymers and UHMW block copolymers of the present disclosure. The methods are based on reversible-deactivation radical polymerization (RDRP). For example, the methods are a combination of Cu-mediated RDRP and RAFT polymerization. FIG. 2 is an example of a method of the present disclosure.

In an example, a UHMW polymer or a UHMW block copolymer is made using a combination of Cu-mediated RDRP and RAFT polymerization. In an example, porogen block(s) is/are made using Cu-mediated RDRP and matrix block(s) is/are made using RAFT polymerization. The Cu-mediated RDRP and RAFT polymerization can be performed in any order. In an example, Cu-mediated RDRP is performed first (e.g., to make a porogen block) and RAFT polymerization performed second (e.g., to make a matrix block).

For Cu-mediated RDRP, various monomers such as, for example, acrylates, methacrylates, vinyl pyridines, and the like, or acid-reactive group functionalized or base-reactive group functionalized analogs thereof can be used. Combinations of monomers can be used. Any monomer that does not bind Cu can be used. Examples of methacrylate monomers include, but are not limited to, solketal methacrylate (SM), methyl methacrylate (MMA), 2-hydroxyethyl methacrylate (HEMA), and the like, and acid-reactive group functionalized or base-reactive group functionalized analogs thereof.

The methods can use one or more of the following:
Cu⁰ wire (or Cu powder);
Me₆TREN and other ligands (e.g., ATRP ligands) that comprise 3 or 4 nitrogen coordination sites;
DMSO and other very polar solvents (DMF, NMP, alcohols, water);
Initiator (e.g., dithioesters and trithiocarbonate).
   In an example, the methods are halide-free. Examples of suitable ATRP ligands are known in the art.

The RAFT polymerization can be carried out using know methods. WO1998001478 describes an example of RAFT polymerization, the disclosure of which with respect to RAFT polymerization methods is incorporated herein by reference. In an example, RAFT polymerization acrylate monomers, methacrylate monomers, styrenic moieties (e.g., styrene moieties), and the like can be used.

In an aspect, the present disclosure provides uses of UHMW block copolymers of the present disclosure. For example, UHMW block copolymers are used as materials for ultrafiltration membranes. Examples of ultrafiltration membranes comprising UHMW block copolymers and methods of making UHMW block copolymers are provided in Example 2. In various examples, an ultrafiltration membrane is used in water-filtration methods, water-purification methods, separation methods (such as, for example, bioseparation methods), drug delivery methods, and ultrafiltration methods, and nanofiltration methods.

In an example, an ultrafiltration membrane comprises a porous support film/membrane and a thin-film comprising one or more UHMW block copolymer. The thin-film comprising one or more UHMW block copolymer is disposed on at least a portion of or all of a porous surface of a support film/membrane. The ultrafiltration membrane can be referred to as a composite membrane. It may be desirable for the porous support material has pores much larger than the pores in the membrane. It may be desirable for the porous support material provides a flat surface.

Various support films/membranes can be used. A support film/membrane is porous. Examples of support films/membranes are known in the art. In various examples, a support film has a plurality of pores having a size (e.g., the longest dimension (e.g., diameter) of a plane defining an orifice of a pore) of 0.1-100 microns, including all 0.1 micron values and ranges therebetween, and/or a thickness of 1-100 microns, including all 0.1 micron values and ranges therebetween.

In an example, a method of forming an ultrafiltation membrane comprises:

1) Coating a porous support film with a thin layer of water.
2) Adding a UHMW block copolymer solution in a water immiscible organic solvent (e.g., a drop) on top of water. Organic solvent spreads into a thin layer on top of water. Polymer concentration is adjusted based on the desired film thickness.
3) Evaporating the organic solvent (to form polymer film on water), and water (to bring together the block polymer film and the underlying porous substrate) to form a composite membrane.
4) Contacting the produced composite membrane with an acidic solution to promote ketal deprotection and pore formation.

In an example, an ultrafiltration membrane is made by coating a porous support film (e.g., PAN, PVDF, glass, polycarbonate, polyethersulfone (PES), cellulose, and the like) with a thin layer of water; depositing a UHMW block copolymer solution in a water immiscible organic solvent (e.g., a drop of solution) on top of water, wherein the solution spreads into a thin layer on top of water; evaporating the organic solvent (to form polymer film on water) and subsequently water (to bring together the UHMW block copolymer film and the underlying porous substrate to form a composite membrane). Solvent evaporation can be carried out without any particular conditions (e.g., allowing the solvent to evaporate under ambient conditions). Water evaporation can be carried out by, for example, air drying, drying in a vacuum oven, use of negative pressure from underneath (from side of support layer that is not in contact with the selective layer), and the like.

In an example, an ultrahigh molecular weight (˜900 kg/mol) polystyrene-poly(solketal methacrylate) block copolymer, which forms a cylindrical morphology, was used to prepare ultrathin polymer membranes (<100 nm). Commercially available PAN350 was used as a porous support. Vertical orientation of cylindrical pores was achieved by a combination of high molecular weight of the utilized block copolymer (large pitch size) and small thickness of the polymer film layer deposited on water. Despite large pitch sizes of the utilized block copolymer, small pores are obtained by removing 20% of the porogen block (during ketal deprotection), as opposed to complete removal of the porogen block. The PAN350 membrane support was activated by soaking in ethanol (˜24 hours) followed by immersing in MilliQ water (˜24 hours). PAN350-polymer composite membrane fabrication. A 1 wt. % solution of PSM-b-PS in toluene was prepared and passed through a 0.25 μm filter. The PAN350 support was coated with a layer of MilliQ water then a drop of PSM-b-PS solution was placed on top of the water layer. Toluene and water were allowed to evaporate from the PAN350-polymer composite at ambient conditions then in a vacuum oven overnight. The dried composite was soaked in 1.5 M HCl solution at 65° C. for 1 hour to hydrolyze the ketal groups on the PSM-b-PS copolymer. The resulting membrane was rinsed with DI water after hydrolysis and was stored in DI water.

The thin-film of the ultrafiltration membrane can be formed from UHMW block copolymers having various molecular weights. In an example, the UHMW block copolymer has a molecular weight (MW) (Mw or Mn) of 100-2000 kg/mol, including all integer kg/mol values and ranges therebetween. The UHMW block copolymer comprises one or more block with base-responsive or acid-responsive functional groups (e.g., ketal groups) (acid-responsive block(s)). It is desirable that the UHMW block copolymer comprises a hydrophobic block with high glass transition temperature (above room temperature).

Polymer concentration is adjusted based on the desired film thickness. For example, the concentration of the UHMW polymer or block copolymer solution is 0.1-10 wt % (based on the total weight of the solution), including all wt % values and ranges therebetween. Increased concentration results in thicker films.

The UHMW block copolymer thin-film can have various thicknesses. In an example, the UHMW block copolymer thin-film has a thickness (e.g., a dimension perpendicular to the longest dimension of the thin-film) of 20 to 200 nm, including all integer nm values and ranges therebetween.

The composite membrane (e.g., PSM-PS) can be contacted with a basic solution or acidic solution to react (e.g., at least partially or completely react) with the responsive block (e.g., base-responsive or acid-responsive block, respectively) to form a porous thin film. An example, of an acid solution is an HCl solution with a pH less than 7. The deprotection, at least partial or complete deprotection, removes the porogen block to produce pores and provide a hydrophilic coating. The reaction with acidic solution forms neutral —OH, which is important for avoidance of biofouling.

A porous UHMW thin-film is hydrophilic. For example, a porous UHMW thin-film has a contact angle of 0° to 60°, including all 0.1° values and ranges therebetween. Contact angle can be measured by methods known in the art. For example, contact angle is measured by a method described herein.

In an example, contacting the composite membrane with an acidic solution promotes ketal deprotection and pore formation. For example, in the case of ketal weight fraction in the porogen block of 20%, maximum 20% of the ketal groups is removed.

Pore size of the UHMW block copolymer thin film can vary. The pore size can vary based on, for example, block copolymer structure, molecular weight, etc. Pore size is controlled by the pitch size of the block copolymer, composition of the block copolymer and the amount of porogen phase removed. For example, the pore size of the UHMW block copolymer is 1-50 nm, including all 0.1 nm values and ranges therebetween.

An ultrafiltration membrane can be subjected to one or more post fabrication processes. The one or more post fabrication processes can be used to control pore size. In various examples, an ultrafiltration membrane is subjected to periodic acid treatment, exposure to UV radiation, treatment with potassium permanganate, treatment with various diboronic acids, and the like.

The pore size of the UHMW block copolymer film can be uniform (e.g., pores having a size of 1-50 nm). The UHMW block copolymer film can have various pore densities. In an example, the UHMW block copolymer film has a pore density of 1.5-54×10⁹ pores/cm². Pore density can be determined by methods known in the art. For example, based on hexagonally packed cylindrical morphology, pore density=1/(d*cos 30)², where d is block copolymer pitch.

The pores have substantially uniform alignment. Without intending to be bound by any particular theory, it is considered that vertical orientation of cylindrical pores is due to film thickness—pores are forced into orientation perpendicular to film surface—since pitch size is large, thicker films can be made.

In an example, an ultrahigh molecular weight (˜900 kg/mol) polystyrene-poly(solketal methacrylate) block copolymer and PAN350, which was used as a porous support, were used to form an ultrafiltration membrane. The UHMW block copolymer thin film of the ultrafiltration membrane had a thickness of less than 100 nm, a high density of pores (e.g., 6×10⁹ pores/cm²).

The ultrafiltration membranes can be hydrophilic and resistant to biofouling. The methods used to make the ultrafiltration membranes are amenable to scalable and cost-effective manufacturing.

The ultrafiltration membranes can be used in purification methods. For example, a method of purification of a water sample comprises contacting an ultrafiltration membrane of the present disclosure with a water sample, where one more contaminants are at least partially or completely removed from the water sample. Non-limiting examples of contaminants include bacteria, viruses, other toxins, and the like.

The ultrafiltration membranes can be used in protein purification methods. An ultrafiltration membrane can be used to isolate one or more proteins from a liquid protein sample. The ultrafiltration membranes can be also used in dialysis methods. For example, an ultrafiltration membrane can be used in hemodialysis methods.

The purification may be based on protein size. For example, desired proteins (e.g., proteins of a particular weight and/or composition) pass through the membrane and undesired proteins (e.g., proteins of a particular weight and/or composition) remain on the surface of the membrane. In another example, undesired proteins (e.g., proteins of a particular weight and/or composition) and/or toxins pass through the membrane and desired proteins (e.g., proteins of a particular weight and/or composition) remain on the surface of the membrane.

In an aspect, the present disclosure provides devices comprising one or more ultrafiltration membrane of the present disclosure. In an example, a device is a filtration or purification device. Example of filtration devices include, but are not limited to, water filtration devices, water purification devices, and the like.

The steps of the methods described in the various embodiments and examples disclosed herein are sufficient to carry out the methods of the present disclosure. Thus, in an example, a method consists essentially of a combination of the steps of the methods disclosed herein. In another example, the method consists of such steps.

The following Statements provide examples of the UHMW polymers and block copolymers of the present disclosure, method of making the polymers and block copolymers, and uses of the polymers and block copolymers.

Statement 1. A membrane (e.g., an ultrafiltration membrane) comprising: a layer comprising an UHMW block copolymer of the present disclosure (e.g., a block copolymer with a molecular weight (Mw or Mn) of 500 kg/mol or greater (e.g., 500 kg/mol to 2000 kg/mol) and a first block (e.g., a porogen block or a minority block) that is 10-65% (e.g. 10-50%) weight fraction (based on the total weight of the copolymer) of the copolymer and comprises a plurality of pendant acid-reactive groups and/or a plurality of pendant base-reactive groups; and a second block (e.g., a matrix block or a majority block) that is 35-90% (e.g., 50-90%) weight fraction (based on the total weight of the copolymer) of the copolymer); and a porous support film, where the layer is disposed on at least a portion of a surface of the porous support film.
Statement 2. A membrane according to Statement 1, where first block comprises acrylate moieties, methacrylate moieties (e.g., solketal methacrylate moieties), acrylamide moieties, methacrylamide moieties, or a combination thereof, where the moieties (e.g., a plurality of the moieties) have at least one acid-reactive group or at least one base-reactive group.
Statement 3. A membrane according to Statement 1 or 2, where the acid-reactive groups are (e.g., independently at each occurrence in the copolymer) chosen from ketal groups, acetal groups, ester groups, anhydride groups, carbonate groups, silyl ether groups, and combinations thereof.
Statement 4. A membrane according to any one of the preceding Statements, where the base-reactive groups are (e.g., independently at each occurrence in the copolymer) chosen from ester groups, anhydride groups, carbonate groups, silyl ether groups, and combinations thereof.
Statement 5. A membrane to any one of the preceding Statements, where the first block has 10-100 mol percent (based on the moles of repeat moieties in the first block) moieties comprising acid-reactive groups or base-reactive groups.
Statement 6. A membrane to any one of the preceding Statements, where the first block has a molecular weight (Mw or Mn) of 200-2000 kg/mol.
Statement 7. A membrane to any one of the preceding Statements, where second block comprises acrylate moieties, methacrylate moieties, vinyl pyridine moieties, styrene moieties, saturated or unsaturated aliphatic moieties, or a combination thereof.
Statement 8. A membrane to any one of the preceding Statements, where the second block has a molecular weight (Mw or Mn) of 200-2000 kg/mol.
Statement 9. A membrane to any one of the preceding Statements, where the first block is a poly(solketal methacrylate) (PSM) block and the second block is a polystyrene block (e.g., where the copolymer molecular weight (Mn) is 500-1,500 kg/mol and/or PSM wt % in the block copolymer is 15-30% or 31-65%).
Statement 10. A membrane to any one of the preceding Statements, where the second block has a glass transition temperature (T_{g}) above room temperature (e.g., above 20° C.).
Statement 11. A membrane to any one of the preceding Statements, where acid-reactive groups are chiral acid-reactive groups comprising one or more chiral center (e.g., solketal groups and groups comprising an amino acid residue) and/or the base-reactive groups are chiral base-reactive groups comprising one or more chiral center, where, optionally, all of groups have the same chiral center.
Statement 12. A membrane to any one of the preceding Statements, where the copolymer has a molecular weight of 600 kg/mol or greater, 700 kg/mol or greater, 800 kg/mol or greater, 900 kg/mol or greater, or 1,000 kg/mol or greater.
Statement 13. A membrane to any one of the preceding Statements, where the porous support film comprises polyacrylonitrile (PAN), polyvinylidene difluoride (PVDF), glass, polycarbonate, polysulfone, polyethersulfone (PES), polyester, cellulose, or a combination thereof.
Statement 14. A membrane to any one of the preceding Statements, where the layer has a thickness of 20-200 nm.
Statement 15. A membrane to any one of the preceding Statements, where the layer has spherical, cylindrical, lamella, or network morphology.
Statement 16. A membrane to any one of the preceding Statements, where the layer has a plurality of domains (e.g., spherical, cylindrical, lamellar domains, or a combination thereof) having a domain size or pitch of 50-300 nm.
Statement 17. A membrane to any one of the preceding Statements, where at least a portion of the acid-reactive groups or at least a portion of the base-reactive groups are removed from the copolymer and the membrane is porous.
Statement 18. A membrane according to Statement 17, where the membrane has a plurality of pores having a pore size (i.e., the longest dimension (e.g., diameter) of a plane defining an orifice of a pore) 1-50 nm.
Statement 19. A membrane according to Statement 17, where the membrane has a pore density of 1.5-54×10⁹ pores/cm².
Statement 20. A block copolymer with a molecular weight of 500 kg/mol or greater (e.g., 500 kg/mol to 2000 kg/mol) comprising: a first block (e.g., a porogen block or a minority block) that is 10-65% (e.g. 10-50%) weight fraction of the copolymer and comprises a plurality of acid-reactive group and/or a plurality of base-reactive groups; and a second block (e.g., a matrix or a majority block) that is 35-90% (e.g., 50-90%) weight fraction of the copolymer.
Statement 21. A block copolymer according to Statement 20, where first block comprises acrylate moieties, methacrylate moieties (e.g., solketal methacrylate moieties), acrylamide moieties, methacrylamide moieties, or a combination thereof, where the moieties (e.g., a plurality of the moieties) have at least one acid-reactive group or at least one base-reactive group.
Statement 22. A block copolymer according to Statement 20 or 21, where the acid-reactive groups are chosen (e.g., independently at each occurrence in the copolymer) from ketal groups, acetal groups, ester groups, anhydride groups, carbonate groups, silyl ether groups, and combinations thereof.
Statement 23. A block copolymer according to any one of Statements 20-22, where the base-reactive groups are chosen (e.g., independently at each occurrence in the copolymer) from ester groups, anhydride groups, carbonate groups, silyl ether groups, and combinations thereof.
Statement 24. A block copolymer according to any one of Statements 20-23, where the first block has a molecular weight of 200-2000 kg/mol.
Statement 25. A block copolymer according to any one of Statements 20-24, where second block comprises acrylate moieties, methacrylate moieties, vinyl pyridine moieties, styrene moieties, saturated or unsaturated aliphatic moieties, or a combination thereof.
Statement 26. A block copolymer according to any one of Statements 20-25, where the second block has a molecular weight of 200-2000 kg/mol (e.g., 300-2000 kg/mol).
Statement 27. A block copolymer according to any one of Statements 20-26, where the first block is a poly(solketal methacrylate) (PSM) block and the second block is a polystyrene block (e.g., where the copolymer molecular weight (Mn) is 500-1,500 kg/mol and/or PSM wt % in the block copolymer is 15-30% or 31-65%).
Statement 28. A block copolymer according to any one of Statements 20-27, where the copolymer has a molecular weight of 600 kg/mol or greater, 700 kg/mol or greater, 800 kg/mol or greater, 900 kg/mol or greater, or 1,000 kg/mol or greater.
Statement 29. A method of making a membrane of Statement 1 comprising: coating a porous support film with a thin layer (e.g., 0.1-2 mm thickness) of water (e.g., by depositing water on a surface of the membrane and allowing it to spread across at least a portion of the surface of the membrane); depositing a solution comprising a copolymer and a water-immiscible organic solvent, where the copolymer is dissolved in the water-immiscible organic solvent, on top of the water, where the solution forms a layer disposed on the water (e.g., depositing a drop of solution at the surface of water and let it spread at the air-water interface); evaporating the water-immiscible organic solvent organic solvent, where the copolymer forms a film disposed on the water; and evaporating the water, where the membrane is formed.
Statement 30. The method according to Statement 29, where the water-immiscible organic solvent is allowed to evaporate under ambient conditions.
Statement 31. The method according to Statement 29 or 30, where the water evaporation comprises air drying, drying in a vacuum oven, use of negative pressure applied to a surface of the support layer that is not in contact with the selective layer).
Statement 32. A method of making a copolymer (or a polymer) (e.g., an UHMW block copolymer or UHMW polymer of the present disclosure) of the comprising: a copper-mediated (e.g., Cu(0) mediated) and halide-free reversible-deactivation radical polymerization (RDRP) (e.g., a combination of a RAFT polymerization and ATRP); and a reversible addition-fragmentation chain transfer polymerization (RAFT polymerization).
Statement 33. The method of Statement 32, where the copper-mediated, halide-free RDRP is carried out first and the RAFT polymerization is carried out after the RDRP.
Statement 34. The method of Statement 32, where the RAFT polymerization is carried out first and the copper-mediated, halide-free RDRP is carried out after the RAFT polymerization.
Statement 35. The method of Statement 32, where the RDRP and/or RAFT polymerization are carried out in a solvent comprising dimethylsulfoxide (DMSO) (e.g., in DMSO).
Statement 36. A method according to Statement 32, comprising: forming a reaction mixture (e.g., a first reaction mixture) (e.g., an RDRP reaction mixture) comprising: one or more first monomers, where, optionally, at least one of the first block monomer(s) comprise one or more acid-reactive groups or one or more base-reactive groups; and one or more RDRP initiators (e.g., dithioesters, trithiocarbonates, dithiocarbamates, xanthates, and the like); one or more amine ligands (e.g., Me6TREN, ATRP ligands, for example, with 3 or 5 nitrogen coordination sites, and the like); one or more copper catalysts (e.g., Cu(0) catalysts); and a solvent (e.g., DMSO, NMP, alcohols, water, and the like, and combinations thereof); and maintaining the reaction mixture at or heating the reaction mixture to a temperature of 20 to 150° C. (e.g., for 5 minutes to 10 hours), where a block comprising a plurality of polymerized first monomers is formed, optionally, isolating the block comprising a plurality of polymerized first monomers from the reaction mixture (e.g., by precipitating the block comprising a plurality of polymerized first monomers using a non-solvent).
37. A method according to Statement 36, further comprising: forming a second reaction mixture comprising the block comprising a plurality of polymerized first monomers; one or more second block monomers to the reaction mixture (e.g., to form RAFT reaction mixture), where, the second block monomer(s) do not comprise one or more acid-reactive groups or one or more base-reactive groups, a solvent (e.g., toluene, DMF, benzene, dioxane, ethylacetate, and the like, and combinations thereof), and optionally, and one or more radical initiator; and maintaining the reaction mixture at or heating the reaction mixture to a temperature of 20 to 150° C. (e.g., for 5 minutes to 10 hours), where a block comprising a plurality of polymerized second monomers covalently bound to the block comprising polymerized first monomers is formed and the copolymer is formed, and, optionally, isolating the copolymer from the reaction mixture (e.g., by precipitating the block comprising a plurality of polymerized first monomers using a non-solvent).
Statement 38. A method according to Statement 32, comprising: forming a reaction mixture (e.g., a first reaction mixture) (e.g., an RAFT polymerization reaction mixture) comprising: one or more block monomers (e.g., second block monomer(s)), where the block monomer(s) do not comprise one or more acid-reactive groups or one or more base-reactive groups, one or more RDRP initiators (e.g., dithioesters, trithiocarbonates, and the like), a solvent (e.g., toluene, DMF, benzene, dioxane, ethylacetate, and the like, and combinations thereof), and optionally, and one or more radical initiator; and maintaining the reaction mixture at or heating the reaction mixture to a temperature of 20 to 150° C. (e.g., for 5 minutes to 10 hours), where a block comprising a plurality of polymerized block monomers that do not comprise one or more acid-reactive groups or one or more base-reactive groups is formed, and, optionally, isolating the block comprising a plurality of polymerized monomers that do not comprise one or more acid-reactive groups or one or more base-reactive groups from the reaction mixture (e.g., by precipitating the block comprising a plurality of polymerized first monomers using a non-solvent).
Statement 39. The method of Statement 38, further comprising: forming a second reaction mixture comprising: the block comprising a plurality of polymerized second monomers; one or more block monomers (e.g., first block monomer(s)) to the reaction mixture (e.g., to form a RDRP reaction mixture), where, the block monomer(s) comprise one or more acid-reactive groups or one or more base-reactive groups, one or more amine ligands (e.g., Me6TREN, ATRP ligands, for example, with 3 or 5 nitrogen coordination sites, and the like), one or more copper catalysts (e.g., Cu(0) catalysts), and a solvent (e.g., DMSO, NMP, alcohols, water, and the like, and combinations thereof) to the reaction mixture comprising the block comprising a plurality of polymerized first monomers; and maintaining the reaction mixture at or heating the reaction mixture to a temperature of 20 to 150° C. (e.g., for 5 minutes to 10 hours), where a block comprising a plurality of polymerized second monomers covalently bound to the block comprising polymerized first monomers is formed and a copolymer is formed, optionally, isolating the copolymer from the reaction mixture (e.g., by precipitating the block comprising a plurality of polymerized first monomers using a non-solvent).
Statement 40. A device comprising one or more membrane of the present disclosure (e.g., one or more membrane of any one of Statements 1-19 and/or one or more membrane made by any one of Statements 29-39).
Statement 41. A device according to Statement 40, where the device is a filtration device, a purification device, dialysis (e.g., hemodialysis) device.
Statement 42. A device according to Statement 40 or 41, where the device is a water filtration device or a water purification device.
Statement 43. A method of water purification comprising: contacting a water sample comprising one or more contaminant with a device of the present disclosure (e.g., a device of any one of Statements 40-42); and collecting the water sample that has passed through the membrane, where one or more contaminant is at least partially or completely removed from the water.
Statement 44. The method of Statement 43, where the contacting further comprises applying pressure to the water sample or reducing the pressure on a side of the membrane opposite that of the water sample.
Statement 45. A method according to Statement 43 or 44, where the water sample is drinking water, surface water, groundwater, lake water, river/stream water, industrial service water, potable water, municipal or industrial effluent, agricultural runoff, or the like.
Statement 46. A method according to any one of Statements 43-45, where the contaminant is chosen from bacteria, viruses, other toxins, or a combination thereof.
Statement 47. A method of dialyzing a sample comprising: contacting a sample (e.g., blood) comprising one or more contaminant (e.g., toxins) with a device of the present disclosure (e.g., a device of Statements 40-42); and collecting the blood that has not passed through the membrane, where one or more contaminant (e.g., toxin) is at least partially or completely removed from the sample (e.g., blood).

The following examples are presented to illustrate the present disclosure. They are not intended to limiting in any matter.

### Example 1

The following example describes ultrahigh molecular weight linear block copolymers.

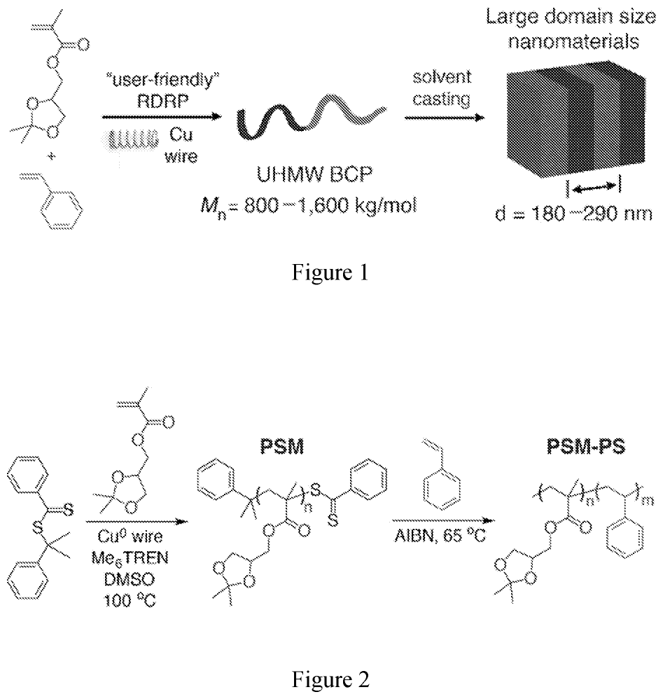

In the example, we disclose a simple and “user-friendly” method for the preparation of ultrahigh molecular weight linear block copolymers (e.g., ultrahigh molecular weight linear poly(solketal methacrylate-b-styrene) block copolymers by a combination of Cu-wire-mediated ATRP and RAFT polymerizations) that readily assemble into highly desirable periodic nanostructures with large domain sizes (>150 nm) and photonic properties (FIG. 1). The synthesized copolymers with molecular weights up to 1.6 million g/mol and moderate dispersities readily assemble into highly ordered cylindrical or lamella microstructures with domain sizes as large as 292 nm, as determined by ultra-small-angle x-ray scattering and scanning electron microscopy analyses. Solvent cast films of the synthesized block copolymers exhibit stop bands in the visible spectrum correlated to their domain spacings. The described method opens new avenues for facilitated fabrication and the advancement of fundamental understanding of BCP-derived photonic nanomaterials for a variety of applications.

In this example, we describe a robust RDRP protocol for the synthesis of UHMW polymethacrylates and their block copolymers with styrene (FIG. 2). The utilized method is halide-free, does not require any sensitive catalysts/reagents to start the process and relies on a combination of Cu-mediated RDRP and RAFT polymerization. We also demonstrate that upon simple solvent casting, these copolymers readily self-assemble into photonic nanomaterials with domain sizes as large as 292 nm, which we believe to be the largest reported for a pure linear BCP.

Materials.

Solvents and reagents were purchased from commercial sources and used directly without purification unless noted otherwise. Azobis(isobutyronitrile) (AIBN) was recrystallized from methanol. DMSO was vacuum distilled and stored over 4 Å molecular sieves. Styrene (S), methyl methacrylate (MMA), and solketal methacrylate (SM) were passed through basic alumina column prior to polymerization to remove any inhibitors. SM and tris-(2-dimethylaminoethyl)amine (Me₆TREN) were prepared according to literature procedures. 2-hydroxyethyl methacrylate (HEMA) and Cu⁰ wire (20 gauge, length=5 mm) were purified using literature procedures.

Measurements.

All ¹H NMR spectra were recorded on a Varian INOVA-500 (500 MHz) spectrometer by using CDCl₃, d₆-DMSO, or CD₂Cl₂ as solvent. Size exclusion chromatography (SEC) analyses were performed using Viscotek's GPC Max and TDA 302 Tetradetector Array system equipped with two PLgel PolyPore columns (Polymer Laboratories, Varian Inc.). The detector unit contained refractive index, UV, viscosity, low (7°), and right angle light scattering modules. Measurements were carried out in THF as the mobile phase at 30° C. The system was calibrated with 10 polystyrene standards having molecular weights ranging from 1.2×10⁶ to 500 g/mol. Refractive index increments (dn/dc) for PMMA, PSM, and acetylated PHEMA were measured to be 0.089, 0.067, and 0.071 mL/g in THF (T=30° C.; λ=630 nm), respectively, and were used to determine the absolute molecular weights of the homopolymers. Scanning electron microscopy (SEM) images were obtained by a Carl Zeiss AURIGA instrument using secondary electron detector at an accelerating voltage of 3.0 kV. Prior to SEM analysis, fractured polymer samples were coated with a 1-2 nm gold layer. Optical measurements were obtained from an Ocean Optics spectrometer with a thermal light source (Euromex). Transmission measurements were done on samples sandwiched between glass microscope slides that were mounted on a copper mask. The samples were scanned from 190 to 850 nm with an integration time of 1 s. Sample transmission data were normalized against the transmission data through a copper mask. Ultra-small-angle X-ray Scattering (USAXS) and pinhole SANS measurements were performed at the Advanced Photon Source (APS) beamline 9ID-C at the Argonne National Laboratory. USAXS and pinhole SANS data were sequentially acquired and was merged into a single dataset using the Irena SAS package.

SM Polymerization.

Solketal methacrylate (1 mL, 5.13 mmol), Me₆TREN (0.68 μL, 2.54 μmol), Cu⁰ wire (9 pieces), and DMSO (0.48 mL) were added to a reaction flask. Subsequently, a solution of cumyl dithiobenzoate in DMSO (0.0815 M) was added to the flask (31.5 μL, 2.56 μmol). The mixture was then degassed by three cycles of freeze-pump-thaw, and placed in an oil bath at 100° C. After a predetermined time, the flask was cooled to room temperature, and an aliquot of the solution was taken for percent conversion analysis by ¹H NMR. The contents of the flask were diluted with dichloromethane and passed through a neutral alumina column, then precipitated in methanol (twice). The polymer was dried overnight under vacuum.

MMA Polymerization.

Methyl methacrylate (1 mL, 9.42 mmol), Me₆TREN (1.3 μL, 4.86 μmol), Cu⁰ wire (9 pieces), and DMSO (0.44 mL) were added to a reaction flask. Subsequently, a solution of cumyl dithiobenzoate in DMSO (0.0816 M) was added to the flask (58.3 μL, 4.75 μmol). The mixture was then degassed by three cycles of freeze-pump-thaw, and placed in an oil bath at 100° C. After a predetermined time, the flask was cooled to room temperature, and an aliquot of the solution was taken for percent conversion analysis by ¹H NMR. The contents of the flask were diluted with dichloromethane and passed through a neutral alumina column, then precipitated in methanol (twice). The polymer was dried overnight under vacuum.

HEMA Polymerization.

2-Hydroxyethyl methacrylate (1 mL, 8.24 mmol), a solution of Me₆TREN in DMSO (0.0799 M) (1.3 μL, 4.86 μmol), Cu⁰ wire (9 pieces), and DMSO (2 mL) were added to a reaction flask. Subsequently, a solution of cumyl dithiobenzoate in DMSO (0.0767 M) was added to the flask (53.2 μL, 4.08 μmol). The mixture was then degassed by three cycles of freeze-pump-thaw, and placed in an oil bath at 100° C. After a predetermined time, the flask was cooled to room temperature, and an aliquot of the solution was taken for percent conversion analysis by ¹H NMR. The contents of the flask were diluted with methanol and passed through a neutral alumina column then precipitated in diethyl ether (twice). The polymer was dried overnight under vacuum. PHEMA was acetylated for SEC analysis in THF. PHEMA (20 mg) was dissolved in 0.50 mL of pyridine. Acetic anhydride (0.1 mL) was added dropwise to the solution, and the mixture was stirred at room temperature for 12 h. After the reaction, the mixture was diluted with dichloromethane, then precipitated in methanol (twice). The polymer was dried overnight under vacuum to yield a white solid.

Example Synthesis of PSM-PS (SK-2).

PSM homopolymer=401,900 g/mol, 0.096 g, 0.24 μmol) and AIBN (0.02 μmol from 7 mM stock solution in styrene) were dissolved in styrene (1.06 mL, 9.25 mmol) in a reaction flask equipped with a stir bar. This mixture was allowed to stir until the solids were completely dissolved. The mixture was then bubbled with N₂ for 15 minutes, and placed in an oil bath at 65° C. After 24 h, the flask was cooled to room temperature and the contents were diluted with dichloromethane and precipitated in hexanes (twice). The resulting polymer was suspended in boiling acetonitrile to remove residual PSM homopolymer. The polymer was then dried overnight under vacuum to yield a powdery solid (94 mg). SEC (polystyrene calibration): Mₙ=296 kg/mol, Ð=1.63; ¹H NMR: n(PS)=2,880.

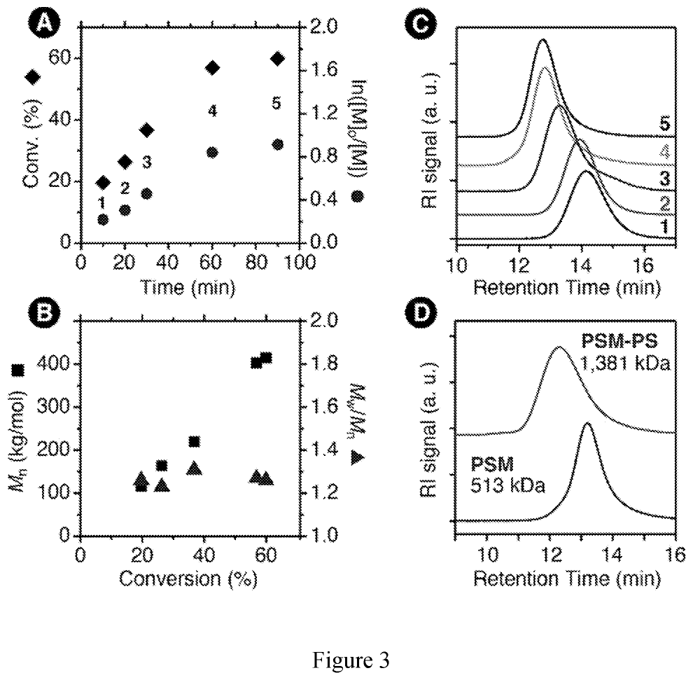

Results and Discussion: Controlled polymerization of solketal methacrylate (SM) was conducted using a Cu(0)-mediated RDRP procedure, where cumyl dithiobenzoate (CDB) served as the initiator, copper wire as the catalyst precursor, and Me₆TREN as the ligand (FIG. 2). The polymerization followed a first-order behavior and produced PSM polymers with low dispersities (Ð), featuring linear evolution of polymer molecular weight with monomer conversion (FIG. 3). The obtained Mₙ values were consistently higher than theoretically predicted ones, likely due to low initiation efficiency. The reaction was rapid, reaching 60% conversion (Mₙ=402 kg/mol, Ð=1.27) in one hour, after which it abruptly stopped, possibly due to high viscosity of the reaction medium. Under more dilute conditions (1M), higher conversions (78%) could be achieved, but polymer dispersity increased significantly (1.90). We also conducted control experiments in the absence of CDB, Cu wire or Me₆-TREN. In each case, less than 5% conversion was obtained after 90 min, indicating that all three components were necessary for the successful outcome of the polymerization.

Cu(0) has the ability to activate radical initiators in the presence of a ligand, and has been reported to facilitate the synthesis of UHMW polymers. Initiating radicals are generated from the CTA in the presence of a Cu(I) catalyst; and owing to rapid chain transfer facilitated by CTAs, polymers with low dispersities are produced even in the absence of deactivating Cu(II) species. It was previously demonstrated that methyl methacrylate can also be polymerized in a controlled fashion in the presence of only a RAFT CTA dithioester and Cu(0)/N,N,N′,N″,N″-pentamethyldiethylenetriamine (PMEDTA) catalyst in DMSO. The polymerization was relatively slow, and the synthesis of UHMW polymers was not attempted. Generally, even in the presence of Cu(0), methacrylates require long reaction times (24-120 h) to produce polymers with ultrahigh molecular weights. In this work, we utilized the capacity of Cu(0)-Me₆TREN catalyst system to enhance polymerization rates, and the control provided by CDB via the RAFT process, to develop a polymerization protocol that produced high molecular weight polymethacrylates in a rapid but controlled manner. Solketal methacrylate was chosen due to its fast polymerization kinetics and a latent diol functionality, which will be exploited in future publications. While SM provided the best results, we successfully applied similar conditions to achieve controlled polymerization of other methacrylates, such as MMA and HEMA.

UHMW block copolymers were prepared by taking advantage of the dithioester end-groups on the PSM to promote RAFT polymerization of styrene (FIG. 2), notorious for its low kₚ values. We found that using high monomer-to-CTA ratio and stopping the reaction at low conversions (˜10%) afforded the desired copolymers. Thus, a polystyrene (PS) block with Mₙ=420 kg/mol can be installed in 24 h by a simple RAFT polymerization in the presence of PSM macro-CTA. The polymerization was twice as fast as a similar RAFT polymerization of styrene conducted in the presence of a small molecule CTA (5.9% conversion after 24 h). We attribute this behavior to a decrease in the rate of diffusion-limited termination processes when macro-CTA is used, which aids the formation of UHMW polystyrene block copolymers. The SEC traces of the block copolymers appeared at lower retention times, compared to the macro-CTA agent (FIG. 3d), and exhibited moderate increase in dispersity values (Ð=1.4-1.6) (Table 1). Relatively high dispersity of the PS block is expected here as a result of extremely low concentrations of the dithiobenzoate end groups, which will make it harder for the addition reaction of the RAFT process to compete with monomer propagation, resulting in broadening of the molecular weight distribution. After polymerization, the product was washed in boiling acetonitrile (selective solvent for PSM) to remove unreacted PSM chains and in cyclohexane (selective solvent for PS) to remove any polystyrene homopolymer byproduct. These treatments did not produce significant changes in the molecular weight distribution of the copolymers. The length of the PS block was calculated from NMR spectra by comparing the signal integral areas of the aromatic PS peak at 6.3-7.3 ppm to that of the PSM peak at 4.3 ppm. Using these methodology, a series of block copolymers with varying molecular weights and polystyrene volume fractions were obtained (Table 1). One must note that these copolymers do not boast low dispersity values. Recent studies have shown that high chain length dispersity in block copolymers, while having an impact of the phase diagram, does not preclude the formation of well-ordered morphologies with uniform microdomain sizes. It does, however, have a generally favorable impact on polymer rheological properties and processing.

TABLE 1
Structural and morphological characteristics of PSM-PS block
copolymers.

| | | M_{n,total} | | | |
|---|---|---|---|---|---|
| polymer | f_{PS}^{a} | (g/mol)^{b} | Ð^{c} | d (nm)^{d} | Morph.^{e} |
| SK-1 | 0.46 | 9.7 × 10⁵ | 1.49 | 209 | C |
| SK-2 | 0.42 | 7.0 × 10⁵ | 1.63 | 178 | C/L |
| SK-3 | 0.62 | 1.4 × 10⁶ | 1.39 | 235 | L |
| SK-4 | 0.64 | 1.1 × 10⁶ | 1.63 | 222 | L |
| SK-5 | 0.58 | 9.7 × 10⁵ | 1.60 | 257 | L |
| SK-6 | 0.72 | 1.6 × 10⁶ | 1.39 | 292 | L |

^{a}Volume fraction of PS.
^{b}Calculated from a combination of SEC-LS and ¹H NMR analyses.
^{c}Determined by SEC in THF using PS calibration.
^{d}Principal domain spacing from USAXS.
^{e}Determined by USAXS and SEM (L: lamella, C: cylinders).

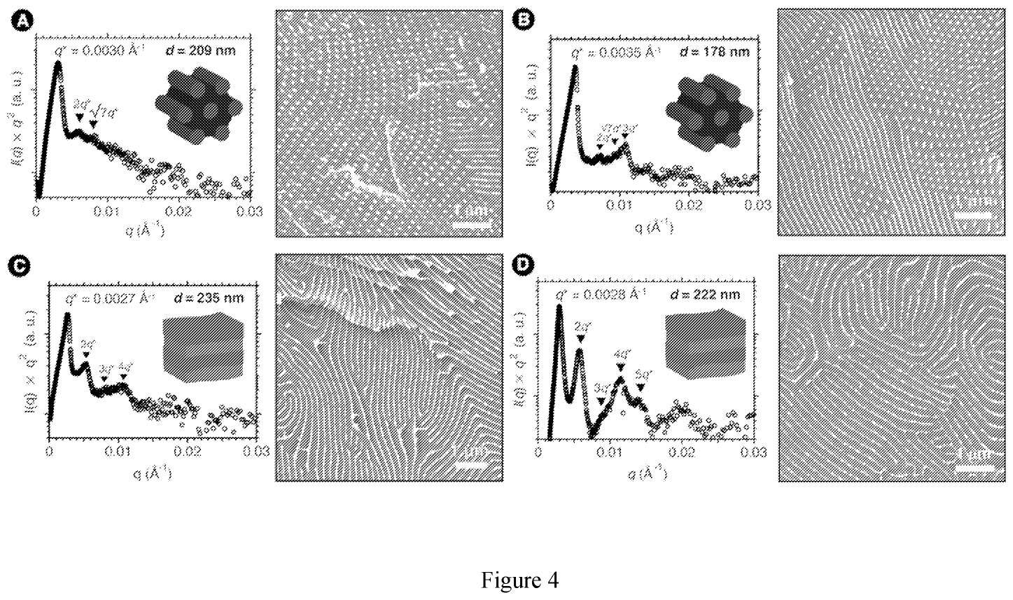

Differential scanning calorimetry analysis of the block copolymer powders revealed two distinct glass transitions, corresponding to the phase separated PSM and PS domains. Free-standing films of the block copolymers were prepared by solvent casting from o-xylene or toluene. Ultra-small angle x-ray scattering (USAXS) analysis of the copolymer films showed a strong primary scattering peak and a number of higher order Bragg reflections, suggesting the formation of highly ordered periodic nanostructures despite chain length dispersity. Domain sizes were calculated from USAXS data to be in the range of 180-290 nm (Table 1). Scanning electron microscopy (SEM) analysis in conjunction with USAXS data allowed for unambiguous identification of the lamella and cylindrical morphologies (Table 1). As shown in FIG. 4d, copolymer SK-4 featured 5 higher order reflections in the USAXS pattern, indicating the formation of an ordered lamella morphology with 222 nm domain spacing. Copolymer SK-1, on the other hand, exhibited a hexagonally packed cylindrical morphology with domain spacing of 209 nm, as characterized by SEM and USAXS (FIG. 4a).

Morphological characterization of the synthesized block copolymers revealed a shift in the phase boundaries consistent with the disperse nature of the PS block. For example, asymmetric copolymer SK-6 (f_{PS}=0.72) formed lamella morphology (expected for monodisperse BCPs with f_{A}=0.4-0.6), while nearly symmetric copolymer SK-1 (f_{PS}=0.46) exhibited cylindrical morphology. These results suggest that the interfaces curve towards PS domains (containing chains with high chain length dispersity), as has been observed for other disperse block copolymers. Additionally, we speculate that BCP chain length dispersity aids in the formation of large domain spacing nanomaterials in two ways: by lattice spacing dilation, which results in domain sizes larger than what is expected from a monodisperse BCP with similar composition, and by improved kinetics due to the presence of shorter chains.

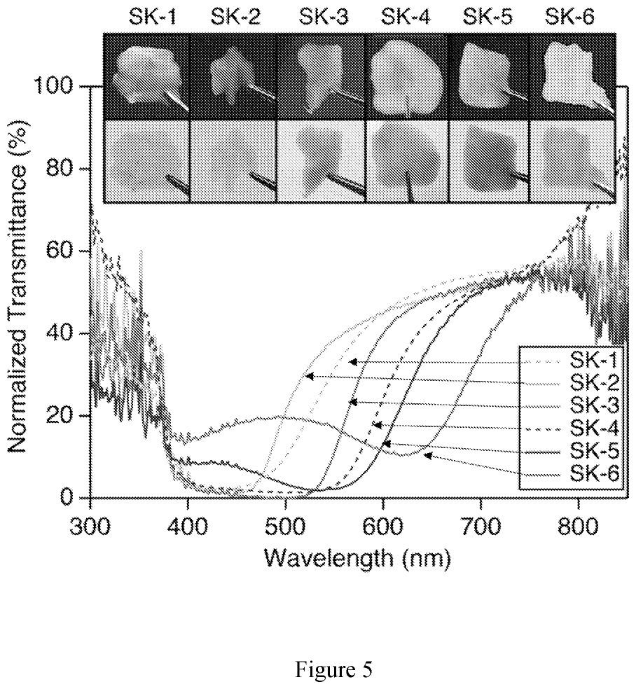

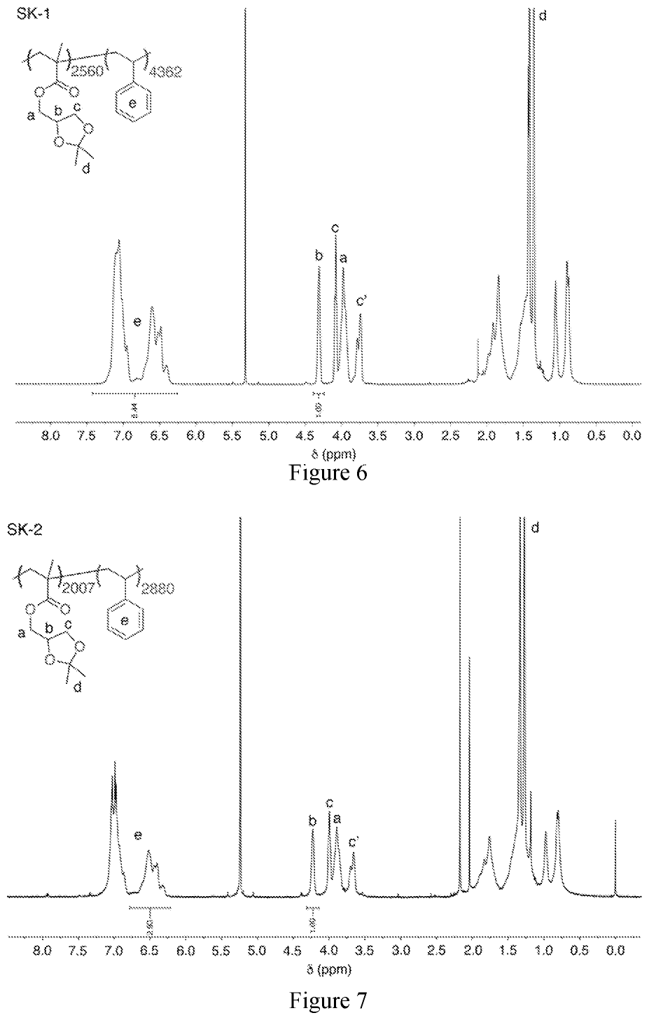

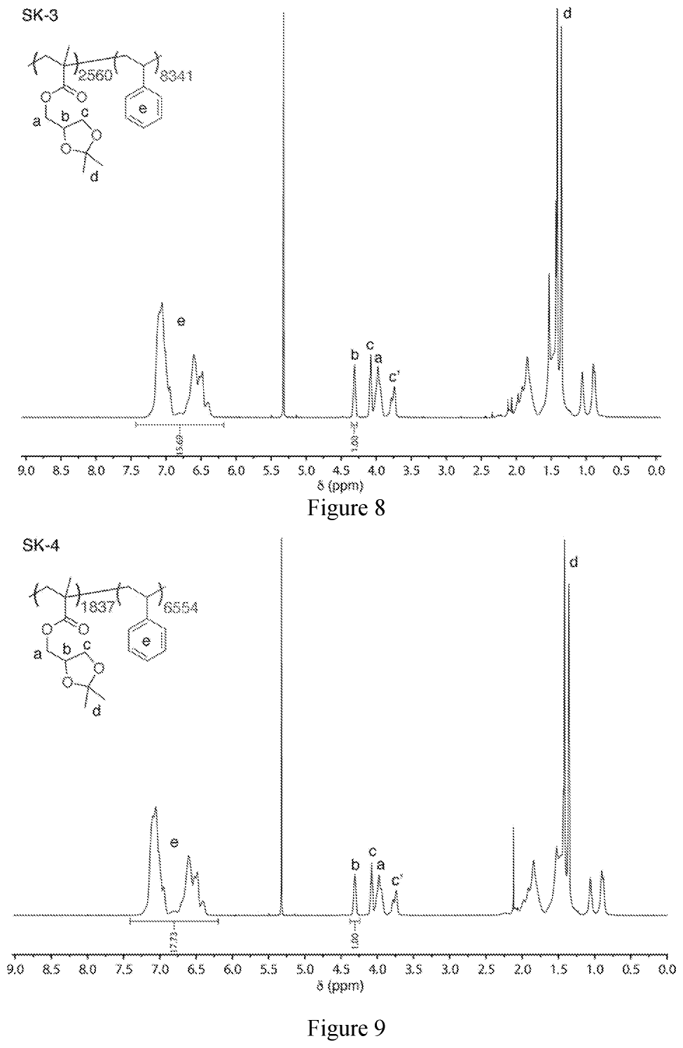

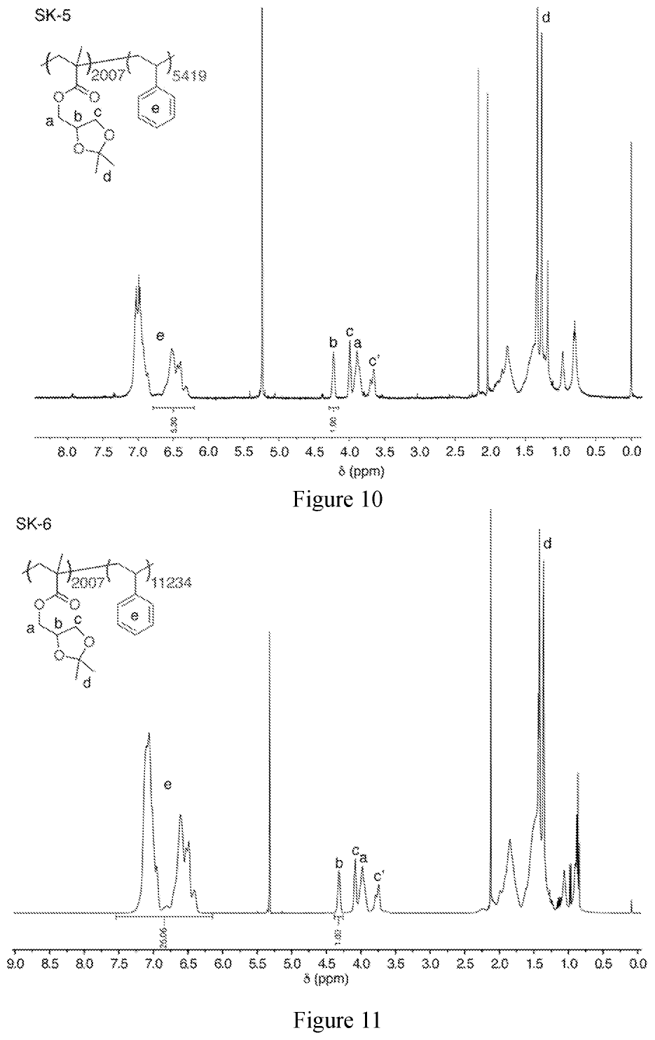

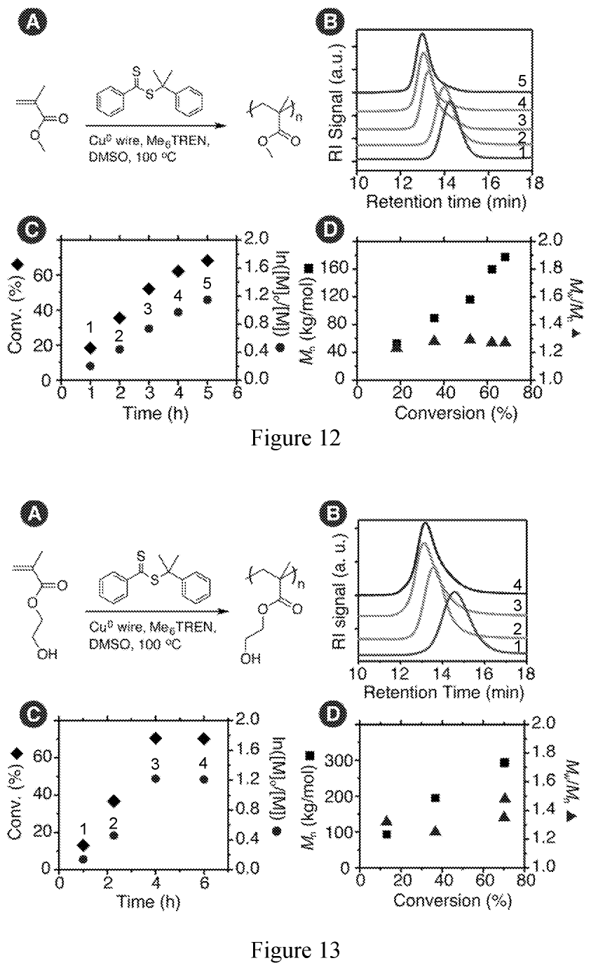

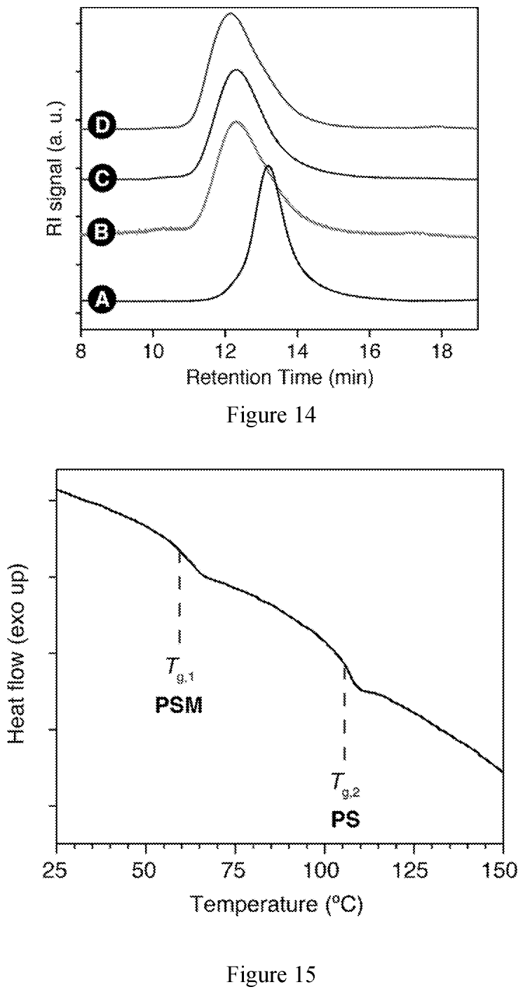

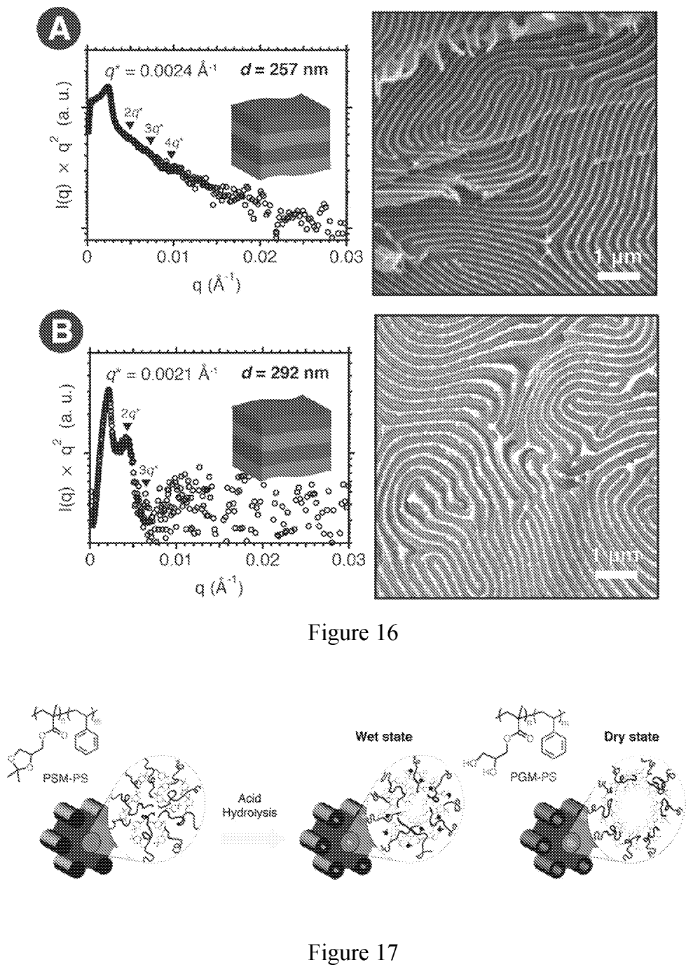

Photonic crystals are materials having periodic dielectric structures that introduce an optical band gap, which can manipulate and control the propagation of light. In particular, if the periodic structures have an optical thickness of a quarter of the wavelength it is possible to construct a highly reflective mirror. Self-assembled linear block copolymers have been shown to exhibit photonic band gaps in the short visible wavelength range, often with help of additives (homopolymer or solvent) to swell the microdomains. The copolymer films produced in this work appeared colored to a naked eye without the need for any additives or manipulations. As evidenced from the preliminary optical characterization (FIG. 5), the transmission spectra of the PSM-PS films featured a highly reflective spectral band (stop band), whose wavelength increased with increasing domain spacing obtained from USAXS, showing a good correlation between the materials microstructure and its optical properties.

Conclusions: In summary, we developed a simple RDRP-based protocol for the preparation of UHMW linear block copolymers. Cu-wire-mediated process in the presence of Me₆-TREN and cumyl dithiobenzoate provided rapid access to high molecular weight poly(solketal methacrylate). RAFT polymerization of styrene initiated from dithiobenzoate end-groups of PSM allowed for the formation of PSM-PS block copolymers with molecular weights up to 1.6 million g/mol. Despite chain length dispersity, the synthesized copolymers readily assembled into highly ordered morphologies with uniform microdomain sizes as high as 292 nm. Lamella and cylindrical morphologies were observed by USAXS and SEM analyses at polymer compositions skewed toward high polystyrene content compared to monodisperse block copolymers, consistent with the presence of a disperse polystyrene block. Ordered block copolymer films exhibited photonic properties with stop bands in the visible spectrum. The access to BCP-based large domain spacing nanomaterials through a “user-friendly” synthetic protocol is poised to advance their research, applications, and broader impact.

Characterization and synthesis of SK-1: Poly(SM) (Mₙ=512,600 g/mol, 1.092 g, 2.07 μmol) and AIBN (30 μL of 7 mM stock solution, 0.21 μmol) were dissolved in (17.2 mL, 165.3 mmol) of styrene in a reaction flask equipped with a stir bar. This mixture was allowed to stir until the solids were completely dissolved. The mixture was then bubbled with N₂ for 15 minutes, and placed in an oil bath at 65° C. After 24 h, the flask was cooled to room temperature and the contents were diluted with dichloromethane and precipitated in hexanes (twice). The resulting polymer was suspended in boiling acetonitrile to remove residual poly(SM) homopolymer. The polymer was then dried overnight under vacuum to yield a powdery solid (0.918 g). SEC (polystyrene calibration): Mₙ=176 kg/mol, Ð=1.49; ¹H NMR: n(PS)=4,362.

Characterization and synthesis of SK-2: Poly(SM) (Mₙ=401,900 g/mol, 0.096 g, 0.24 μmol) and AIBN (3.4 μL of 7 mM stock solution, 0.02 μmol) were dissolved in (1.1 mL, 9.25 mmol) of styrene in a reaction flask equipped with a stir bar. This mixture was allowed to stir until the solids were completely dissolved. The mixture was then bubbled with N₂ for 15 minutes, and placed in an oil bath at 65° C. After 24 h, the flask was cooled to room temperature and the contents were diluted with dichloromethane and precipitated in hexanes (twice). The resulting polymer was suspended in boiling acetonitrile to remove residual poly(SM) homopolymer. The polymer was then dried overnight under vacuum to yield a powdery solid (0.094 g). SEC (polystyrene calibration): Mₙ=296 kg/mol, Ð=1.63; ¹H NMR: n(PS)=2,880.

Characterization and synthesis of SK-3: Poly(SM) (Mₙ=512,600 g/mol, 0.991 g, 1.88 μmol) and AIBN (20 μL of 7 mM stock solution, 0.14 μmol) were dissolved in (31.2 mL, 271.8 mmol) of styrene in a reaction flask equipped with a stir bar. This mixture was allowed to stir until the solids were completely dissolved. The mixture was then bubbled with N₂ for 15 minutes, and placed in an oil bath at 65° C. After 24 h, the flask was cooled to room temperature and the contents were diluted with dichloromethane and precipitated in hexanes (twice). The resulting polymer was suspended in boiling acetonitrile to remove residual poly(SM) homopolymer. The polymer was then dried overnight under vacuum to yield a powdery solid (1.02 g). SEC (polystyrene calibration): Mₙ=213 kg/mol, Ð=1.39; ¹H NMR: n(PS)=8,341.

Characterization and synthesis of SK-4: Poly(SM) (Mₙ=431,900 g/mol, 0.621 g, 1.48 μmol) and AIBN (20 μL of 7 mM stock solution, 0.14 μmol) were dissolved in (12.5 mL, 108.5 mmol) of styrene in a reaction flask equipped with a stir bar. This mixture was allowed to stir until the solids were completely dissolved. The mixture was then bubbled with N₂ for 15 minutes, and placed in an oil bath at 65° C. After 24 h, the flask was cooled to room temperature and the contents were diluted with dichloromethane and precipitated in hexanes (twice). The resulting polymer was suspended in boiling acetonitrile to remove residual poly(SM) homopolymer. The polymer was then dried overnight under vacuum to yield a powdery solid (1.116 g). SEC (polystyrene calibration): Mₙ=427 kg/mol, Ð=1.64; ¹H NMR: n(PS)=6,554.

Characterization and synthesis of SK-5: Poly(SM) (Mₙ=401,900 g/mol, 0.056 g, 0.14 μmol) and AIBN (1.9 μL of 7 mM stock solution, 0.013 μmol) were dissolved in (1.4 mL, 11.9 mmol) of styrene in a reaction flask equipped with a stir bar. This mixture was allowed to stir until the solids were completely dissolved. The mixture was then bubbled with N₂ for 15 minutes, and placed in an oil bath at 65° C. After 24 h, the flask was cooled to room temperature and the contents were diluted with dichloromethane and precipitated in hexanes (twice). The resulting polymer was suspended in boiling acetonitrile to remove residual poly(SM) homopolymer. The polymer was then dried overnight under vacuum to yield a powdery solid (0.085 g). SEC (polystyrene calibration): Mₙ=339 kg/mol, Ð=1.76; ¹H NMR: n(PS)=5,419.

Characterization and synthesis of SK-6: Poly(SM) (Mₙ=431,900 g/mol, 0.621 g, 1.48 μmol) and AIBN (20 μL of 7 mM stock solution, 0.14 μmol) were dissolved in (12.5 mL, 108.5 mmol) of styrene in a reaction flask equipped with a stir bar. This mixture was allowed to stir until the solids were completely dissolved. The mixture was then bubbled with N₂ for 15 minutes, and placed in an oil bath at 65° C. After 24 h, the flask was cooled to room temperature and the contents were diluted with dichloromethane and precipitated in hexanes (twice). The resulting polymer was suspended in boiling acetonitrile to remove residual poly(SM) homopolymer. The polymer was then dried overnight under vacuum to yield a powdery solid (0.806 g). SEC (polystyrene calibration): Mₙ=218 kg/mol, Ð=1.56; ¹H NMR: n(PS)=11,234.

### Example 2

This examples provides a description of ultrathin isoporous membranes with sub-10 nm pores.

In this example, we present a scalable method of constructing robust ultathin membranes featuring sub-10 nm pore sizes from an ultrahigh molecular weight block copolymer with domain sizes larger than 150 nm, where cylindrical domain orientation is ensured by incommensurability between film thickness and domain spacing, while small pore dimensions are obtained by partial removal of the cylindrical phase.

In this example, we disclose a simple and scalable procedure for the preparation of robust nanoporous composite membranes from ultrahigh molecular weight (UHMW) poly(solketal methacrylate)-polystyrene (PSM-PS) block copolymers, synthesized by “user-friendly” radical polymerization protocols. Perpendicular alignment of domains in ultrathin (60-80 nm) copolymer film was achieved through the incommensurability between film thickness and domain spacing owing to the large domain sizes formed by the UHMW copolymers. Deprotection of ketal groups in the PSM domains results in the formation of membranes with sub-10 nm pore sizes coated with hydrophilic and bioinert poly(glycerol methacrylate) chains, which can also provide a versatile platform for further chemical transformations (FIG. 17). We also determined the morphologies accessible from UHMW linear PSM-PS copolymers, and demonstrated the ability to generate a variety of pore geometries from PSM-PS copolymers exhibiting cylindrical and lamellar nanostructures.

Nanoporous monoliths exhibiting various pore geometries were prepared by self-assembly and selective deprotection of ultrahigh molecular weight (UHMW) linear polystyrene-b-poly(solketal methacrylate) (PS-PSM) copolymers. A series of PSM-PS with molecular weights ranging from 400-1,700 kDa with moderate dispersities were prepared by a “user-friendly” controlled radical polymerization protocol. Phase behavior of the copolymers in solvent cast film were studied by SEM and ultra-small-angle x-ray scattering techniques, which revealed the formation of well-ordered morphologies with domain spacings as large as 339 nm. A robust composite membrane was prepared from an UHMW PSM-PS copolymer exhibiting cylindrical nanostructures without the need for annealing and post-assembly transformation procedures. Rapid, acid-catalyzed selective deprotection of ketal groups of the PSM block results to the formation of cylindrical pores with sub-10 nm diameters deduced from rejection tests using poly(ethylene oxide) solutes.

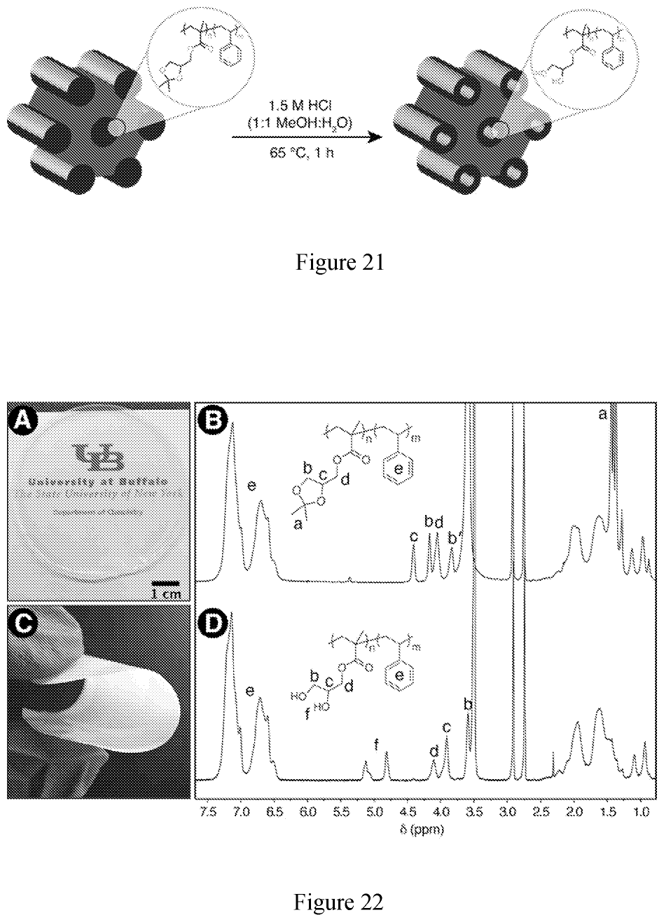

Results and discussion. Block copolymer synthesis. Asymmetrically disperse UHMW linear PSM-PS block copolymers were synthesized by first preparing the PSM homopolymers using a copper-wire-mediated controlled radical polymerization protocol, and subsequently installing the polystyrene (PS) block by reversible addition-fragmentation chain transfer (RAFT) polymerization (FIG. 21).

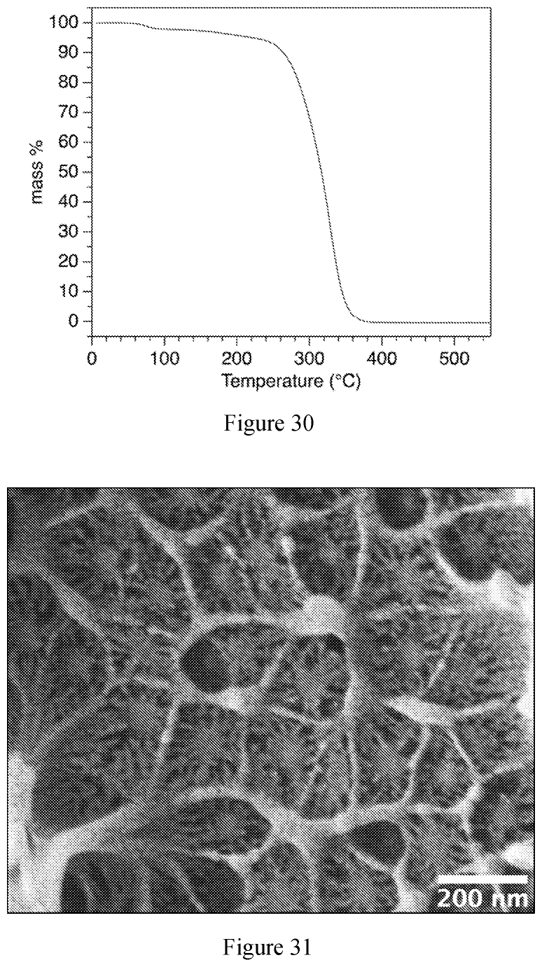

A series of PSM-PS were prepared with molecular weights ranging from 400-1,600 kg/mol and PS volume fractions, f_{PS}, of 0.18 to 0.90. The copolymers exhibited relatively high chain length dispersities, which can be attributed to the slow chain transfer process during the RAFT polymerization of styrene resulting from the use of high molecular weight PSM macro-chain transfer agents and moderate control provided by dithioesters over molecular weight distribution during the RAFT polymerization of styrene. PS block lengths were determined from ¹H NMR using the PSM peak at 4.3 ppm as a reference. The volume fractions of PSM and PS were calculated using the homopolymer densities determined from pycnometer measurements at 24.3° C. with water as the working liquid. PSM and PS homopolymer films were thermally annealed under vacuum at 170° C. to remove any air bubbles that may have been trapped during the film casting process. The annealing temperature was chosen such that it is above the glass transition temperatures (T_{g}) of the homopolymers but below their degradation temperatures. Under an inert atmosphere, PSM exhibits a T_{g} at ˜60° C. and is stable up to ˜250° C. (FIG. 30), while PS displays a T_{g} at ˜100° C. and does not degrade until ˜300° C. The good correlation between experimentally determined homopolymer PS melt density with literature values verifies the accuracy of the pycnometer method in determining polymer melt densities. The measured melt densities of PSM and PS homopolymers were 1.1480 g/mL and 1.0334 g/mL, respectively.

TABLE 2
Characterization of PSM-PS Block Copolymers.

| | Polymer | N_{PSM} | N_{PS} | f=hd PS | M_{n,total}(g/mol) | Nₜₒₜₐₗ | Ðₜₒₜₐₗ | d(nm) | Morphology |
|---|---|---|---|---|---|---|---|---|---|
| JM548 | KS(0.18,720) | 3,000 | 1,110 | 0.18 | 716,300 | 4,110 | 1.61 | 208 | S |
| JM480 | KS(0.35,530) | 1,800 | 1,650 | 0.35 | 532,160 | 3,450 | 1.68 | 126 | C |
| JM537 | KS(0.41,980) | 3,000 | 3,640 | 0.41 | 980,000 | 6,640 | 1.36 | 192 | C |
| JM467 | KS(0.45,635) | 1,840 | 2,560 | 0.45 | 635,280 | 4,400 | 1.52 | 153 | C |
| JM538 | KS(0.46,1650) | 4,620 | 6,970 | 0.46 | 1,650,700 | 11,590 | 1.77 | 339 | C |
| JM468 | KS(0.49,680) | 1,840 | 3,000 | 0.49 | 680,800 | 4,840 | 1.58 | 166 | L |
| JM470 | KS(0.54,520) | 1,260 | 2,590 | 0.54 | 521,600 | 3,850 | 1.38 | 154 | L |
| JM476 | KS(0.59,820) | 1,800 | 4,460 | 0.59 | 825,300 | 6,260 | 1.47 | 180 | L |
| JM536 | KS(0.60,1220) | 2,600 | 6,690 | 0.60 | 1,218,300 | 9,290 | 1.52 | 235 | L |
| JM484 | KS(0.63,397) | 770 | 2,320 | 0.63 | 396,700 | 3,090 | 1.44 | 100 | L |
| JM473 | KS(0.65,420) | 770 | 2,550 | 0.65 | 421,800 | 3,320 | 1.36 | 118 | L |
| JM392 | KS(0.65,1380) | 2,560 | 8,340 | 0.65 | 1,381,300 | 10,900 | 1.39 | 235 | L |
| JM469 | KS(0.67,1050) | 1,840 | 6,550 | 0.67 | 1,050,400 | 8,390 | 1.63 | 222 | L |
| JM471 | KS(0.69,764) | 1,260 | 4,922 | 0.69 | 764,440 | 6,182 | 1.35 | 135 | L |
| JM481 | KS(0.69,760) | 1,260 | 4,910 | 0.69 | 762,700 | 6,170 | 1.35 | 177 | L |
| JM478 | KS(0.70,1131) | 1,800 | 7,398 | 0.70 | 1,130,920 | 9,198 | 1.50 | 261 | L |
| JM474 | KS(0.72,510) | 770 | 3,410 | 0.72 | 509,910 | 4,180 | 1.40 | 169 | L |
| JM383 | KS(0.73,1602) | 2,160 | 11,230 | 0.73 | 1,601,900 | 13,390 | 1.39 | 292 | L |
| JM595 | KS(0.75,910) | 1,260 | 6,360 | 0.75 | 914,000 | 7,620 | 1.54 | 146 | C |
| JM549 | KS(0.76,600) | 770 | 4,250 | 0.76 | 597,000 | 5,020 | 1.78 | 125 | C |
| JM472 | KS(0.77,1030) | 1,260 | 7,450 | 0.77 | 1,027,400 | 8,710 | 1.61 | 153 | C |
| JM475 | KS(0.79,690) | 770 | 5,140 | 0.79 | 689,800 | 5,910 | 1.44 | 147 | C |
| JM482 | KS(0.90,1460) | 770 | 12,520 | 0.90 | 1,458,400 | 13,290 | 1.78 | 251 | S |

Melt Self-Assembly of PSM-PS.

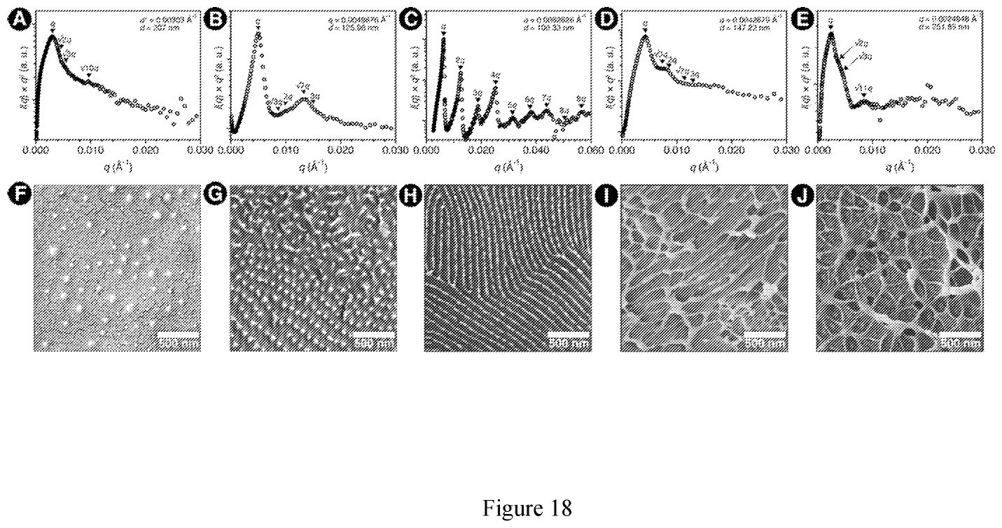

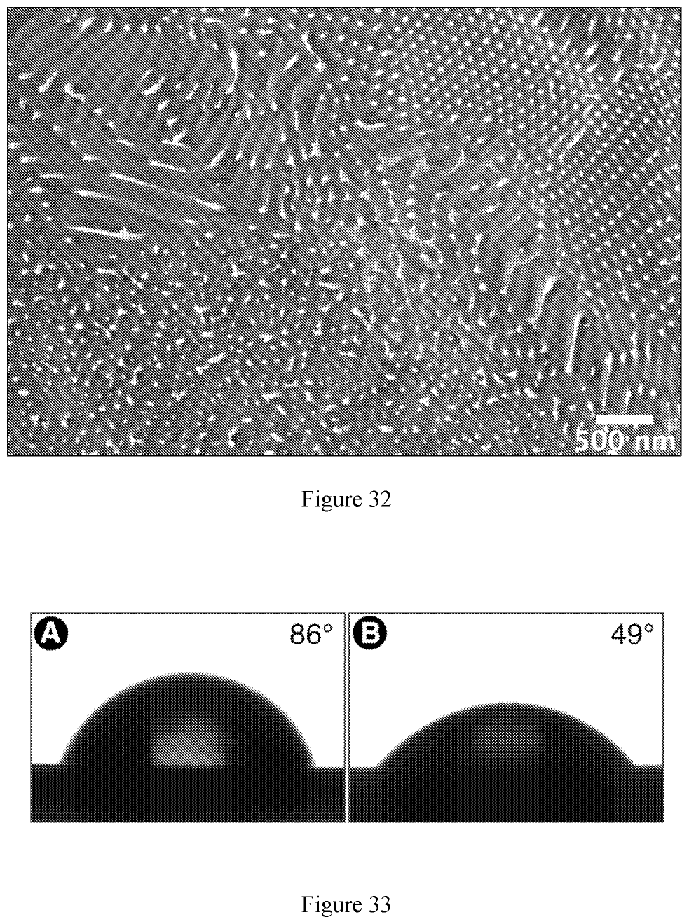

The low kinetic mobility of highly entangled polymer chains presents a barrier to translational ordering of high molecular weight BCPs. However, recent studies have shown that copolymer molecular weight homogeneity is not a prerequisite in the formation of ordered nanostructures and uniform micro-domain sizes; in fact, high dispersity in BCPs demonstrate a favorable impact on rheological properties, which aids in polymer processing. Free-standing films of the PSM-PS copolymers were prepared by solvent casting from toluene and allowing the solvent to evaporate completely over 2 days at ambient conditions. Ultrasmall-angle X-ray scattering (USAXS) analysis of the copolymer films revealed the presence of periodic nanostructures with domain sizes in the range of 100-339 nm. Aside from the high molecular weight of the copolymers, the large domain spacings can also be contributed by the swelling of PSM domains by copolymers with very short PS. According to the scaling law derived from monodisperse PSM-PS copolymers with symmetric compositions, a PSM-PS with a total repeating unit of 4840 and narrow molecular weight distribution is expected to exhibit a domain spacing of 110 nm; however, KS(0.49,680), which has the same number of repeating units but a relatively high dispersity (Ð=1.58), shows a domain spacing of 166 nm, thereby validating that high chain length dispersity leads to lattice spacing dilation. Previous studies on AB diblock copolymers with disperse B block revealed the presence of highly asymmetric chains with very short B blocks within the A domains due to the inability of the short B segments to anchor the polymer chain at the domain interface, which causes the A domain to swell. The block copolymer films exhibit strong primary scattering peaks along with a number of higher order reflections suggestive of ordered nanostructure formation (FIG. 18). In conjunction with USAXS data, the morphologies formed by the block copolymers were unambiguously identified by scanning electron microscopy (SEM) analysis. The broad peaks and limited number of higher order reflections evident from USAXS of the spherical morphologies (FIGS. 18A and E) are attributed to the spherical domains not adopting a perfect BCC arrangement, thus SEM images (FIGS. 18F and J) were exclusively used in these cases to identify the morphology. FIG. 31 provides a higher magnification of the PSM spheres from KS(0.90,1460). Careful inspection of the SEM images (FIGS. 18G and 32) of KS(0.35,530) film reveals a mix of hexagonally packed and disorganized cylinders indicating the proximity of the copolymer sample to the sphere/cylinder phase boundary, which explains the relatively broad peaks in FIG. 18B. Morphologies with good translational ordering can also be obtained from asymmetrically disperse PSM-PS block copolymers as illustrated in FIG. 18H thus, highlighting that chain length heterogeneity is not detrimental to the formation of well-aligned domains. The presence of nine sharp scattering peaks in FIG. 18C is indicative of lamella domains with good long-range ordering. Lastly, disorganized PSM cylindrical domains were formed from KS(0.79,690) based on SEM analysis and the broad scattering peaks from USAXS data. These results illustrate that the presence of a block with high chain length dispersity does not perturb, and may even facilitate, the formation of periodic nanostructures from high molecular weight BCPs without the need for annealing processes.

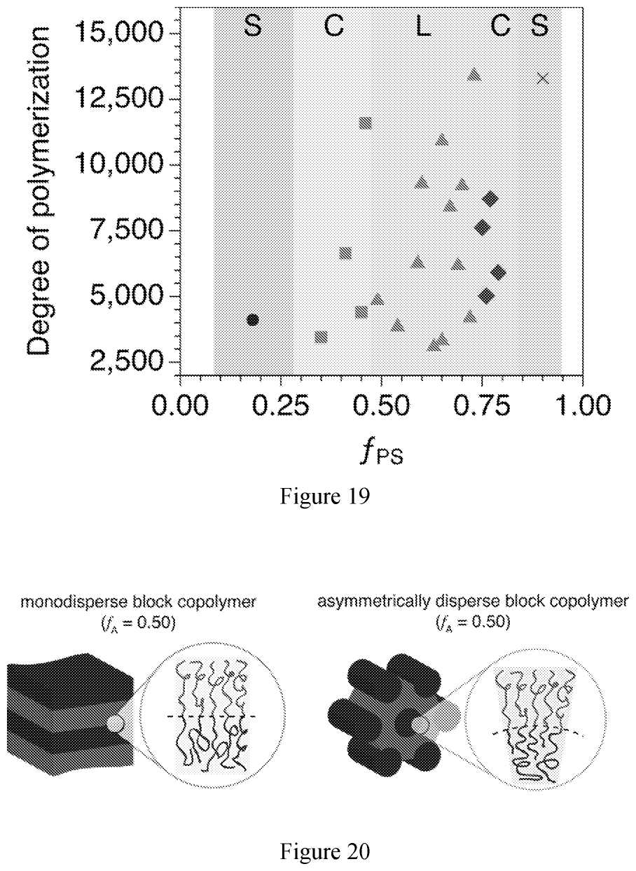

A plot of the accessible equilibrium morphologies for UHMW linear PSM-PS copolymer is presented in FIG. 19. Compositions spanning from 0.10 to 0.20 in the minority component yield spherical domains; cylindrical nanostructures are displayed by copolymers with f_{PS}=0.35-0.46 and 0.75-0.79; and, lamella morphology was formed from copolymers with f_{PS}=0.49-0.73. Relative to the phase diagram for a monodisperse BCP, the phase boundaries for the PSM-PS copolymer containing a disperse PS block are shifted towards higher PS volume fractions consistent with previous studies of AB diblock copolymers bearing asymmetrical dispersity between blocks.

Self-consistent mean-field theory investigation by Sides and Fredrickson revealed that increasing the dispersity in one block results to partitioning of chain lengths within the unit cell; the longer polymer chains fill the center of the domains while the shorter chains are localized at the domain interface. The shorter PS chains localized at the interface act as “co-surfactants” that effectively shield the longer PS chains from the unfavorable enthalpic contacts with the PSM segment, thereby reducing the stretching energy of the PS block. To maintain the balance of stretching energies, the longer PS chains stretch further from the interface to fill the domain uniformly, which results to an increased interfacial curvature towards the disperse PS component. Therefore, the equilibrium morphology adopted by these asymmetrically disperse block copolymers have higher interfacial curvatures compared to its monodisperse counterparts with the same composition as illustrated in FIG. 20.

A 50 μm-thick film of PSM-PS was placed in a 1.5 M HCl (in 1:1 water:methanol) solution and heated to 65° C. Analysis by ¹H NMR revealed the absence of PSM ketal peaks at 1.55 ppm and appearance of hydroxyl protons at 4.8 and 5.1 ppm from poly(glycerol monomethacrylate) (PGM), which confirms complete ketal deprotection after 1 hour of reaction (FIGS. 22B and D). Hillmyer and co-workers previously reported that unaligned cylindrical domains hamper the degradation process and leads to fragmentation of the monolith as a result of grain cleavage. Despite the presence of randomly oriented cylindrical domains, the PSM-PS monoliths remained intact throughout the degradation process since only the ketal portion of the PSM block is removed (FIGS. 22A and C). After hydrolysis, the monolith exhibits macroscopic pliability (FIG. 22C) and has a white, opaque appearance as has been observed in other porous materials post-treatment due to scattering of visible light by the sample. Furthermore, the monolith displayed a lower contact angle value upon hydrolysis indicative of an increase in the hydrophilicity of the copolymer film due to the presence of hydroxyl groups (FIG. 33).

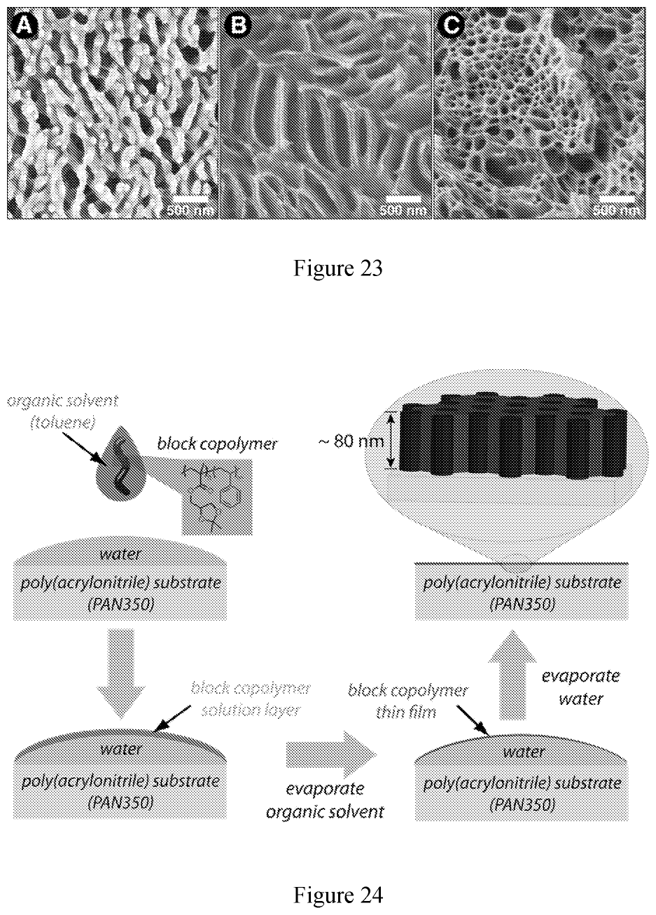

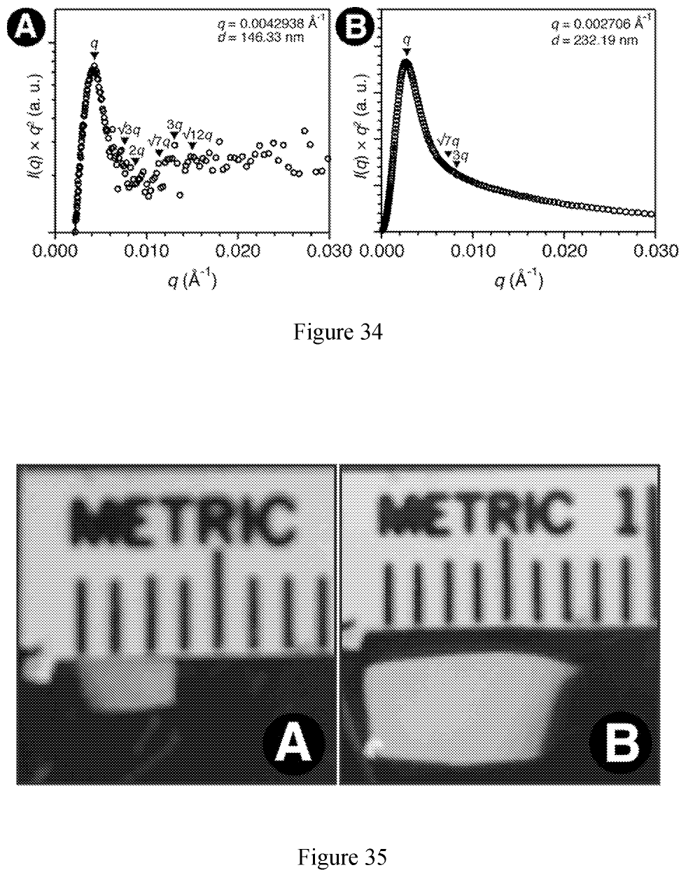

Analysis of USAXS data (FIG. 34) reveals an increase in the domain spacing upon hydrolysis of KS(0.75,910), which may be due to plasticization of the PS domains by acetone, a byproduct of the hydrolysis reaction. Complete hydrolysis of the ketal group inferred from ¹H NMR analysis suggests the existence of interconnected cylindrical domains forming an uninterrupted channel through the entire sample. As an indirect proof, a PSM-PS monolith that self-assembles into randomly oriented PS cylinders was hydrolyzed to reveal the presence of fused cylindrical domains (FIG. 23A). Slit-shaped pores were observed from lamellae-forming PSM-PS copolymers after hydrolysis due to the randomly oriented lamellar domains collapsing in different directions (FIG. 23B). Hydrolysis of a monolith with PS spheres in PSM matrix resulted in a swollen material (FIG. 35), which was not characterized by SEM due to its extremely soft nature from its high water content. Lastly, a sample with PSM spheres in PS matrix did not exhibit a porous structure after acid treatment as expected from a material with the acid sensitive domains embedded within a water impenetrable matrix. Furthermore, the fast ketal deprotection may be attributed to the increased hydration in the PSM/PGM domains during acid hydrolysis and the autocatalytic acceleration of the hydrolysis reaction by the PGM hydroxyl groups.

Membrane Fabrication.

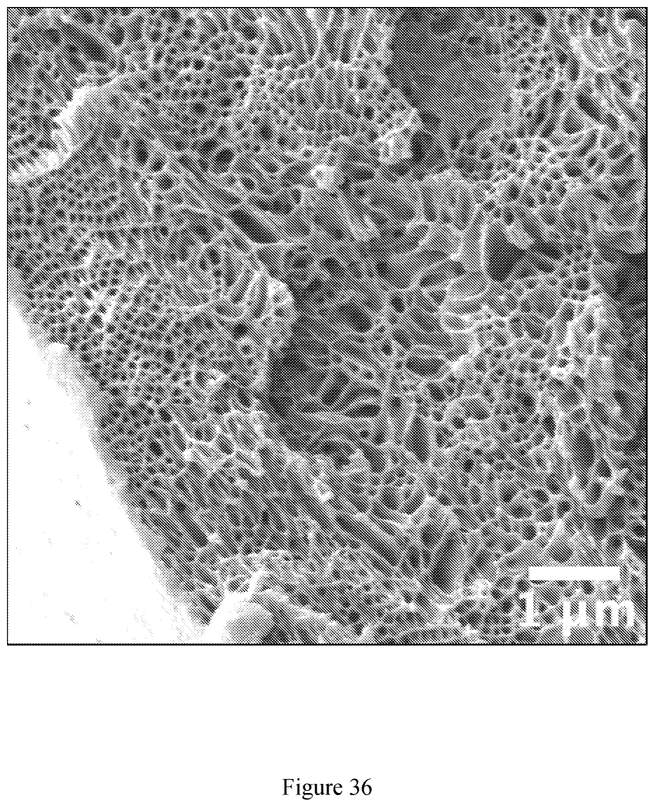

Pore orientation and mechanical stability are some of the requirements for a robust membrane material. In addition to the high molecular weight of the block copolymers, we envision that a porous monolith with a PS matrix would provide the necessary mechanical integrity to the membrane; therefore, KS(0.75,910) was utilized to prepare membrane. However, closer inspection of the SEM image of hydrolyzed KS(0.75,910) reveals hexagonally-packed cylindrical pores aligned parallel to the surface of the monolith (FIG. 36), which precludes it from being used as a membrane. Casting a film with thickness less than the domain spacing and diameter of the cylinders would force the cylindrical domains to adopt a perpendicular orientation. The large domain spacings exhibited by the block copolymers present an advantage because perpendicular alignment can be achieved in ˜100 nm thick films, which help preserve the mechanical integrity of the materials. To construct the filtration membrane, PSM-PS dissolved in toluene were drop casted on a layer of water on top of a microporous poly(acrylonitrile) support (PAN350); a thin copolymer film (˜60-80 nm thick by ellipsometry) forms after evaporation of the organic solvent, which adheres to the underlying support upon complete evaporation of the water layer (FIG. 24).

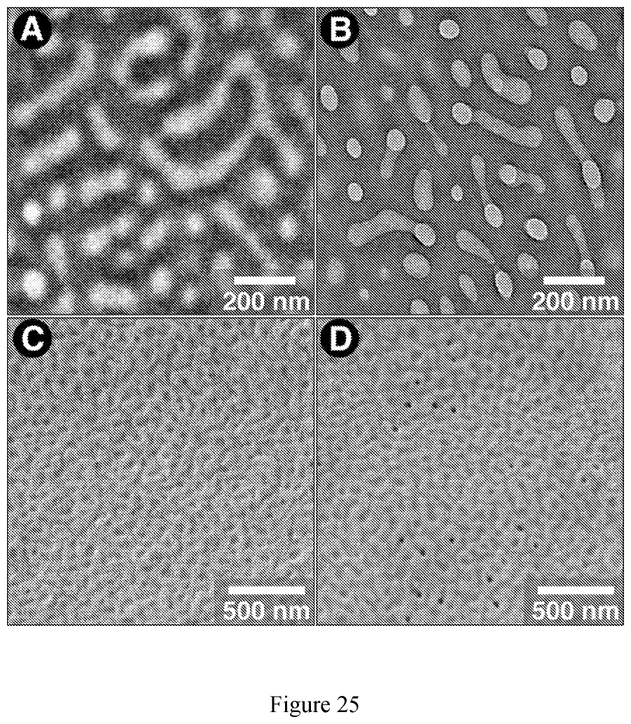

PAN350 was chosen as the support material due to its high molecular weight cutoff (150 kDa), good thermal stability, and resistance against most organic solvents. The composite membranes were able to withstand a pressure of 15 psi for 2 hours in a dead-end filtration setup before water percolates through the membrane thus, exhibiting its mechanical robustness and defect-free nature. SEM analysis of the pristine membrane surface substantiates the absence of defects and also feature the existence of fused cylindrical domains. Upon hydrolysis, no delamination occurred suggesting good adhesion between the copolymer film and PAN350. However, SEM image of the membrane surface after hydrolysis (FIG. 25D) shows a low density of pores and pore sizes of 31±4 nm, which is smaller than the expected 43 nm pore size calculated from USAXS data and an expected 20% weight loss in the PSM domains upon hydrolysis. The low density of pores and discrepancy between the observed and expected pore size may be attributed to Au coating thickness during the SEM sample preparation. It is possible that the visible pores in the SEM image are from cylindrical domains that traverse in a straight path through the film; whereas, pores emanating from slanted cylinders are sealed off during the Au coating step prior to SEM analysis. To verify this hypothesis, thin films were prepared in a similar fashion to the membrane fabrication and subjected to transmission electron microscopy (TEM) analysis. The pristine sample reveals the formation of perpendicularly oriented domains (FIG. 25A), while slanted and fused cylinders are more clearly seen in the hydrolyzed film as indicated by pores located at the end and in the middle of horizontal domains, respectively (FIG. 25B). Furthermore, the measured pore size from the TEM image of hydrolyzed film in the dry state is 40±7 nm, which is in close agreement with the expected pore size.

Membrane Performance.

Narrow dispersity polyethylene oxide (PEO) samples with molecular weights ranging from 1 to 50 kDa were used to probe the size selectivity and determine the molecular weight cutoff (MWCO) of the composite membrane. PEO samples exhibiting well-separated peaks by size exclusion chromatography (SEC) were combined into one feed solution with a total PEO concentration of 1 g/L. The composite membrane exhibits pure water and rejection test flux values of 14 L·m⁻²·h⁻¹·bar⁻¹ and 11 L·m⁻²·h⁻¹·bar⁻¹, respectively. The relative amount of rejected PEO solute was determined by comparing the refractive index (RI) signal areas of the PEO solutes in the feed and permeate solutions. Relative rejection values of the PEO solutes were calculated using Eq. 2, where RI_{feed} and RIₚₑᵣₘₑₐₜₑ denote the areas of the refractive index signals for the PEO solute in the feed and permeate solutions, respectively.

$$\% Rejection = \frac{{RI}_{feed} - {RI}_{permeate}}{{RI}_{feed}} \times 100 \qquad ( 2 )$$

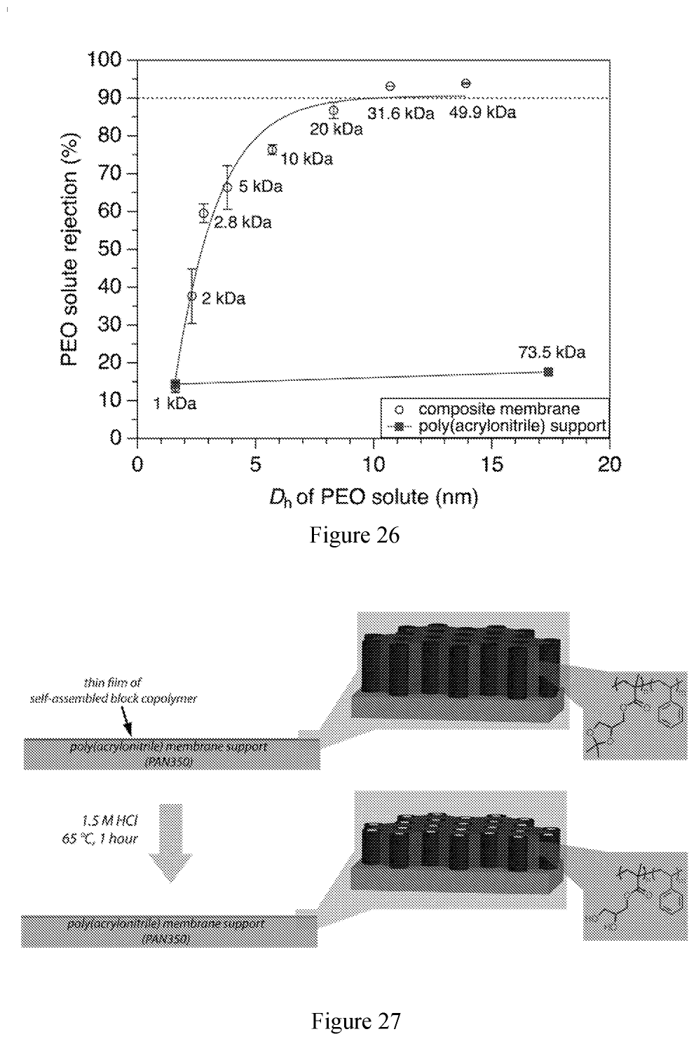

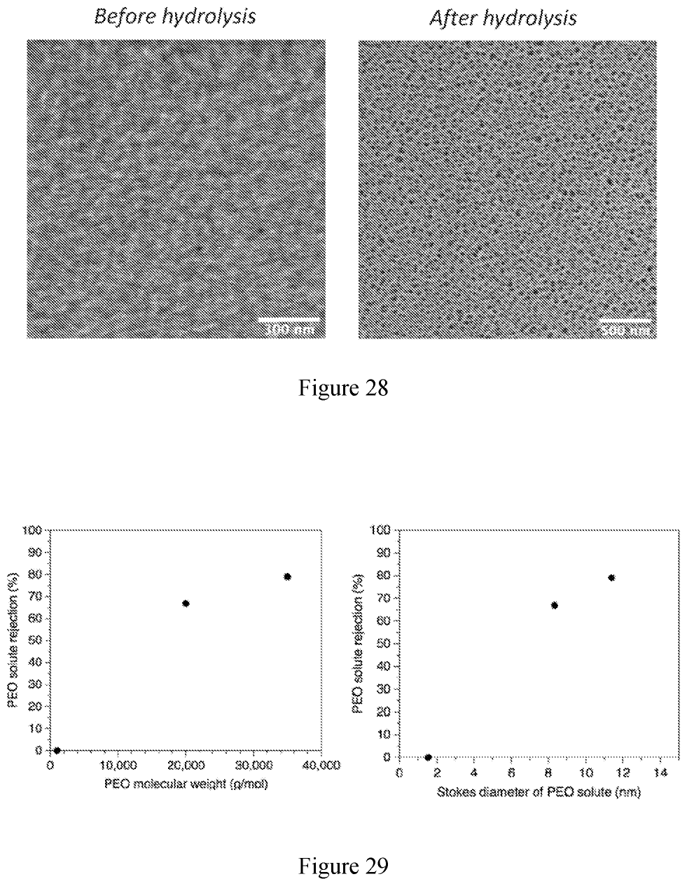

The composite membrane rejects 13% of the 1 kDa PEO and exhibits ˜90% solute rejection for PEO samples with molecular weights greater than 20 kDa (FIG. 26). As a control experiment, PAN350 was treated in the same manner as the composite membrane and was challenged with 1 and 75 kDa PEO. PAN350 exhibited solute rejection values of 14% and 18% for the 1 kDa and 75 kDa PEO samples, respectively. Since PAN350 has a MWCO of 150 kDa, it is likely that the small fraction of the PEO solutes “rejected” by the microporous support are actually adhering to the support material instead of being rejected. Furthermore, the similar rejection values obtained for the 1 kDa PEO solute from PAN350 and the composite membrane indicates that 1 kDa PEO completely passes through the copolymer film layer, and the observed solute rejection from the composite membrane is due to PEO latching onto the microporous support. MWCO is defined as the lowest molecular weight solute that is 90% rejected. The cutoff value determined for the composite membrane was 20 kDa, and the pore size of the selective copolymer film layer is approximately 8 nm based on the hydrodynamic diameter of the 20 kDa PEO. The smaller pore size displayed by the copolymer film in the wet state is due to the swelling of the PGM chains by water. For KS(0.75,910), a fully-stretched PGM chain is expected to span 314 nm, and since the cylindrical domains are only 90 nm in diameter, the domains cannot accommodate PGM chains with completely extended conformations. Instead, the PGM chains are only partially stretched as a result of the propensity of the hydroxyl groups to form hydrogen bonds to water and to other hydroxyl groups.

Conclusion: In summary, we developed a simple and scalable method for the fabrication of composite membranes with sub-10 nm pore size dimensions and determined the equilibrium morphologies for UHMW linear PSM-PS copolymers, which provide access to nanoporous materials with varying pore geometries. High chain length dispersity in the copolymers is hypothesized to facilitate the self-assembly process, which allows the formation of ordered nanostructure even with an enhanced solvent evaporation rate during the composite membrane preparation. The large domain spacings (100-339 nm) displayed by the UHMW copolymers are attributed to the swelling of the domains by very short, highly asymmetric PSM-PS copolymers. Perpendicular alignment of domains from an ˜80 nm thick copolymer film was achieved through the incommensurability between film thickness and domain spacing owing to the large domain spacings formed by the UHMW copolymers. Hydrolysis of a PSM cylinder-forming copolymer monolith resulted to nanoporous structures with pores having diameters of 40 nm in the dry state. However, in the wet state, the PGM chains situated within the pores adopt more extended conformations thus, resulting to a MWCO value of 20 kDa corresponding to a hydrodynamic diameter of ˜8 nm. The hydroxyl groups lining the pore walls impart increased hydrophilicity to pores and is envisaged to provide fouling resistance to the membrane; furthermore, it also provides a handle to functionalize the pore walls for advanced membrane applications.

Methods. Materials. Solvents and reagents were purchased from commercial sources and used directly without purification unless noted otherwise. Azobis(isobutyronitrile) (AIBN) was recrystallized from methanol. DMSO was stored over 4 Å molecular sieves. Styrene and solketal methacrylate were passed through activated basic alumina prior to polymerization to remove inhibitors and adventitious peroxides from the monomers. Poly(solketal methacrylate-b-styrene) block copolymers were prepared using literature procedure. PAN350 supports were activated by soaking in ethanol (˜24 hours) followed by immersing in deionized water (˜24 hours).

Measurements.

All ¹H NMR spectra were recorded on a Varian INOVA-500 (500 MHz) spectrometer by using CD₂Cl₂, or d₇-DMF as solvent. Size exclusion chromatography (SEC) analyses were performed using Viscotek's GPC Max and TDA 302 Tetra detector Array system equipped with two PLgel MIXED-C columns (Agilent). The detector unit contained refractive index, UV, viscosity, low (7°), and right angle light scattering modules. Measurements were carried out in THF with 1 vol % triethylamine as the mobile phase at 30° C. Further GPC data were obtained from Viscotek GPC system equipped with a VE-3580 refractive index (RI) detector, a VE 1122 pump, and two PolyPore columns (Agilent). DMF (HPLC grade) with 0.1 M LiBr was used as a mobile phase with a flow rate of 0.5 mL/min at 55° C. Both systems were calibrated with 10 polystyrene standards having molecular weights ranging from 1.2×10⁶ to 500 g/mol. Refractive index increments (dn/dc) poly(solketal methacrylate) was measured to be 0.067 mL/g in THF (T=30° C.; λ=630 nm) and was used to determine the absolute molecular weight of the homopolymer. Scanning electron microscopy (SEM) images were obtained by a Carl Zeiss AURIGA instrument using secondary electron detector at an accelerating voltage of 3.0 kV. Prior to SEM analysis, fractured polymer samples were coated with a 1-2 nm gold layer. Transmission electron microscopy (TEM) images were obtained using a JEOL 2010 TEM instrument. The TEM samples were prepared by mounting a thin polymer film (<100 nm thick) on a copper grid, which was made by adding 1 drop of the polymer solution (1 wt. % in toluene) on top of water and allowing the organic solvent to completely evaporate. Ellipsometry measurements were done using a FILMETRICS F20 thin-film analyzer. Contact angle measurements were performed on a Rame-hart goniometer, and the contact angle was determined using DROPimage CA software. Ultrasmall-angle X-ray Scattering (USAXS) and pinhole SAXS measurements were performed at the Advanced Photon Source (APS) beamline 9ID-C at the Argonne National Laboratory. USAXS and pinhole SAXS data were sequentially acquired and was merged into a single data set using the Irena SAS package.

Solvent Casting of PSM-b-PS.

Solutions of the copolymers in toluene (10 wt. %) were cast on a Teflon sheet and covered with a glass Petri dish. Toluene was allowed to evaporate slowly (˜3 days) and the films were subsequently dried in a vacuum oven at room temperature.

Ketal Hydrolysis of Free-Standing PSM-b-PS Films.

The ketal groups were hydrolyzed by placing the copolymer films in 1.5 M HCl (3 M methanolic HCl+DI water) at 65° C. After 2 hours, the films were rinsed with methanol and dried in a vacuum oven at room temperature overnight. A portion of the film was dissolved in d₇-DMF for ¹H NMR analysis.

PAN350-Polymer Composite Membrane Fabrication.

PSM-PS is dissolved in toluene to a concentration of 1 wt. %. The resulting solution is then filtered through a 0.45 μm syringe filter to remove dust particles. A drop of the PSM-PS solution is subsequently added on top of a layer of MilliQ water on the activated PAN350 support. The PAN350-polymer composite was allowed to dry at ambient conditions, and was further dried in a vacuum oven overnight. The dried composite was soaked in 1.5 M HCl in methanol/H₂O solution at 65° C. for 1 hour to hydrolyze the ketal groups on the PSM-b-PS copolymer. The resulting membrane was rinsed with MilliQ water after hydrolysis and stored in MilliQ water.

Membrane Performance Tests.

The membranes were tested using a dead-end filtration cell (UHP-43, Sterlitech). A series of poly(ethylene oxide) (PEO) samples with molecular weights ranging from 1,000 to 75,000 Da were utilized in the rejection tests. To perform the solute rejection tests, the cell was initially filled with deionized (DI) water to measure the permeance of pure water through the membrane. The cell is then charged with a mixture of PEO solutes dissolved in DI water to a total concentration of 1 g/L. The solution is pushed through the membrane by applying nitrogen gas (14.5 psi) to the filtration cell. The test is concluded when approximately 10-15 g of the permeate has been collected, which is subsequently transferred to a glass vial for GPC analysis. After every run, the cell is rinsed with DI water followed by flushing fresh DI water through the membrane to remove any adhering PEO solute.

For the GPC analyses, equal volumes of the permeate and feed solutions were lyophilized. After complete removal of water, the resulting PEO solids were dissolved with equal amounts of DMF. The PEO solutions were passed through 0.45 μm syringe filters before injecting into the GPC. The area under the curve for each PEO solute is determined, and percent rejection is calculated using Eq. 2.

Although the present disclosure has been described with respect to one or more particular embodiments and/or examples, it will be understood that other embodiments and/or examples of the present disclosure may be made without departing from the scope of the present disclosure.

1. A membrane comprising:
a layer comprising a copolymer with a molecular weight (Mw or Mn) of 500 kg/mol or greater and
a first block that is 10-65% weight fraction (based on the total weight of the copolymer) of the copolymer and comprises a plurality of pendant acid-reactive groups and/or a plurality of pendant base-reactive groups; and
a second block that is 35-90% weight fraction (based on the total weight of the copolymer) of the copolymer; and
a porous support film,
wherein the layer is disposed on at least a portion of a surface of the porous support film.

2. The membrane of claim 1, wherein first block comprises acrylate moieties, methacrylate moieties, acrylamide moieties, methacrylamide moieties, or a combination thereof, wherein the moieties have at least one acid-reactive group or at least one base-reactive group.

3. The membrane of claim 1, wherein the acid-reactive groups are chosen from ketal groups, acetal groups, ester groups, anhydride groups, carbonate groups, silyl ether groups, and combinations thereof.

4. The membrane of claim 1, wherein the base-reactive groups are chosen from ester groups, anhydride groups, carbonate groups, silyl ether groups, and combinations thereof.

5. The membrane of claim 1, wherein the first block has 10-100 mol percent (based on the moles of repeat moieties in the first block) moieties comprising acid-reactive groups or base-reactive groups.

6. The membrane of claim 1, wherein the first block has a molecular weight (Mw or Mn) of 200-2000 kg/mol.

7. The membrane of claim 1, wherein second block comprises acrylate moieties, methacrylate moieties, vinyl pyridine moieties, styrenic moieties, saturated or unsaturated aliphatic moieties, or a combination thereof.

8. The membrane of claim 1, wherein the second block has a molecular weight (Mw or Mn) of 200-2000 kg/mol.

9. The membrane of claim 1, wherein:
the first block is a poly(solketal methacrylate) (PSM) block and the second block is a polystyrene block.

10. The membrane of claim 1, wherein the second block has a glass transition temperature (T_{g}) above room temperature.

11. The membrane of claim 1, wherein acid-reactive groups are chiral acid-reactive groups comprising one or more chiral center and/or the base-reactive groups are chiral base-reactive groups comprising one or more chiral center.

12. The membrane of claim 1, wherein the copolymer has a molecular weight of 600 kg/mol or greater, 700 kg/mol or greater, 800 kg/mol or greater, 900 kg/mol or greater, or 1,000 kg/mol or greater.

13. The membrane of claim 1, wherein the porous support film comprises polyacrylonitrile (PAN), polyvinylidene difluoride (PVDF), glass, polycarbonate, polysulfone, polyethersulfone (PES), polyester, cellulose, or a combination thereof.

14. The membrane of claim 1, wherein the layer has a thickness of 20-200 nm.

15. The membrane of claim 1, wherein the layer has spherical, cylindrical, lamella, or network morphology.

16. The membrane of claim 1, wherein the layer has a plurality of domains having a domain size or pitch of 50-300 nm.

17. The membrane of claim 1, wherein at least a portion of the acid-reactive groups or at least a portion of the base-reactive groups are removed from the copolymer and the membrane is porous.

18. The membrane of claim 17, wherein the membrane has a plurality of pores having a pore size 1-50 nm.

19. The membrane of claim 17, wherein the membrane has a pore density of 1.5-54×10⁹ pores/cm².

20. A block copolymer with a molecular weight of 500 kg/mol or greater comprising:
a first block that is 10-65% weight fraction of the copolymer and comprises a plurality of acid-reactive group and/or a plurality of base-reactive groups; and
a second block that is 35-90% weight fraction of the copolymer.

21. The block copolymer of claim 20, wherein first block comprises acrylate moieties, methacrylate moieties, acrylamide moieties, methacrylamide moieties, or a combination thereof,
wherein the moieties have at least one acid-reactive group or at least one base-reactive group.

22. The block copolymer of claim 20, wherein the acid-reactive groups are chosen from ketal groups, acetal groups, ester groups, anhydride groups, carbonate groups, silyl ether groups, and combinations thereof.

23. The block copolymer of claim 20, wherein the base-reactive groups are chosen from ester groups, anhydride groups, carbonate groups, silyl ether groups, and combinations thereof.

24. The block copolymer of claim 20, wherein the first block has a molecular weight of 200-2000 kg/mol.

25. The block copolymer of claim 20, wherein second block comprises acrylate moieties, methacrylate moieties, vinyl pyridine moieties, styrenic moieties, saturated or unsaturated aliphatic moieties, or a combination thereof.

26. The block copolymer of claim 20, wherein the second block has a molecular weight of 200-2000 kg/mol.

27. The block copolymer of claim 20, wherein
the first block is a poly(solketal methacrylate) (PSM) block and the second block is a polystyrene block.

28. The block copolymer of claim 20, wherein the copolymer has a molecular weight of 600 kg/mol or greater, 700 kg/mol or greater, 800 kg/mol or greater, 900 kg/mol or greater, or 1,000 kg/mol or greater.

29. A method of making a membrane of claim 1 comprising:
coating a porous support film with a thin layer of water;
depositing a solution comprising a copolymer and a water-immiscible organic solvent, wherein the copolymer is dissolved in the water-immiscible organic solvent, on top of the water, wherein the solution forms a layer disposed on the water;
evaporating the water-immiscible organic solvent organic solvent, wherein the copolymer forms a film disposed on the water; and
evaporating the water,
wherein the membrane is formed.

30. The method of claim 29, wherein the water-immiscible organic solvent is allowed to evaporate under ambient conditions.

31. The method of claim 29, wherein the water evaporation comprises air drying, drying in an oven, drying in a vacuum oven, or use of negative pressure applied to a surface of the support layer that is not in contact with the selective layer.

32. A method of making a copolymer comprising:
a copper-mediated and halide-free reversible-deactivation radical polymerization (RDRP); and
a reversible addition-fragmentation chain transfer polymerization (RAFT polymerization).

33. The method of claim 32, wherein the copper-mediated, halide-free RDRP is carried out first and the RAFT polymerization is carried out after the RDRP.

34. The method of claim 32, wherein the RAFT polymerization is carried out first and the copper-mediated, halide-free RDRP is carried out after the RAFT polymerization.

35. The method of claim 32, wherein the RDRP and/or RAFT polymerization are carried out in a solvent comprising dimethylsulfoxide.

36. The method of claim 32, comprising:
forming a reaction mixture comprising:
one or more first monomers, wherein at least one of the first block monomer(s) comprise one or more acid-reactive groups or one or more base-reactive groups; and
one or more RDRP initiators;
one or more amine ligands;
one or more copper catalysts; and
a solvent; and
maintaining the reaction mixture at or heating the reaction mixture to a temperature of 20 to 150° C.,
wherein a block comprising a plurality of polymerized first monomers is formed,
optionally, isolating the block comprising a plurality of polymerized first monomers from the reaction mixture.

37. The method of claim 36, further comprising:
forming a second reaction mixture comprising
the block comprising a plurality of polymerized first monomers;
one or more second block monomers, wherein, the second block monomer(s) do not comprise one or more acid-reactive groups or one or more base-reactive groups,
a solvent, and
optionally, one or more radical initiator; and
maintaining the reaction mixture at or heating the reaction mixture to a temperature of 20 to 150° C.,
wherein a block comprising a plurality of polymerized second monomers covalently bound to the block comprising polymerized first monomers is formed and the copolymer is formed, and,
optionally, isolating the copolymer from the reaction mixture.

38. The method of claim 32, comprising:
forming a reaction mixture comprising:
one or more block monomers, wherein the block monomer(s) do not comprise one or more acid-reactive groups or one or more base-reactive groups,
one or more RDRP initiators;
a solvent, and
optionally, one or more radical initiator; and
maintaining the reaction mixture at or heating the reaction mixture to a temperature of 20 to 150° C.,
wherein a block comprising a plurality of polymerized monomers that do not comprise one or more acid-reactive groups or one or more base-reactive groups is formed, and,
optionally, isolating the block comprising a plurality of polymerized monomers that do not comprise one or more acid-reactive groups or one or more base-reactive groups from the reaction mixture.

39. The method of claim 38, further comprising:
forming a second reaction mixture comprising:
the block comprising a plurality of polymerized block monomer(s) that do not comprise one or more acid-reactive groups or one or more base-reactive groups;
one or more block monomers, wherein, the block monomer(s) comprise one or more acid-reactive groups or one or more base-reactive groups,
one or more amine ligands,
one or more copper catalysts, and
a solvent, and
maintaining the reaction mixture at or heating the reaction mixture to a temperature of 20 to 150° C.,
wherein a block comprising a plurality of polymerized block monomer(s) that do not comprise one or more acid-reactive groups or one or more base-reactive groups covalently bound to the block comprising polymerized block monomer(s) that comprise one or more acid-reactive groups or one or more base-reactive groups is formed and the copolymer is formed, and,
optionally, isolating the copolymer from the reaction mixture.

40. A device comprising one or more membrane of claim 1.

41. The device of claim 40, wherein the device is a filtration device, a purification device, dialysis device.

42. The device of claim 40, wherein the device is a water filtration device or a water purification device.

43. A method of water purification comprising:
contacting a water sample comprising one or more contaminant with a device of claim 40; and
collecting the water sample that has passed through the membrane,
wherein one or more contaminant is at least partially or completely removed from the water.

44. The method of claim 43, wherein the contacting further comprises applying pressure to the water sample or reducing the pressure on a side of the membrane opposite that of the water sample.

45. The method of claim 43, wherein the water sample is drinking water, surface water, groundwater, lake water, river/stream water, industrial service water, potable water, municipal or industrial effluent, or agricultural runoff.

46. The method of claim 43, wherein the contaminant is chosen from bacteria, viruses, or a combination thereof.

47. A method of dialyzing a sample comprising:
contacting blood comprising one or more toxins with a device of claim 40; and
collecting the blood that has not passed through the membrane,
wherein one or more toxin is at least partially or completely removed from the blood.
